(19) United States
(12) Patent Application Publication
(10) Pub. No.: US 2022/0324707 A1
(43) Pub. Date: Oct. 13, 2022

(54) DRY REFORMING METHANE AND HYDROCARBON MIXTURE FEEDSTOCKS USING CERIA-SUPPORTED METAL CATALYSTS

(71) Applicant: University of Wyoming, Laramie, WY (US)

(72) Inventors: Jing ZHOU, Laramie, WY (US); Joseph HOLLES, Laramie, WY (US); Richard HORNER, Laramie, WY (US); Jintao MIAO, Laramie, WY (US); Daniel BRAEDT, Laramie, WY (US)

(73) Assignee: University of Wyoming, Laramie, WY (US)

(21) Appl. No.: 17/711,365

(22) Filed: Apr. 1, 2022

Related U.S. Application Data
(63) Continuation-in-part of application No. 17/082,406, filed on Oct. 28, 2020.
(60) Provisional application No. 63/169,997, filed on Apr. 2, 2021.
(60) Provisional application No. 62/927,518, filed on Oct. 29, 2019.
(60) Provisional application No. 62/957,962, filed on Jan. 7, 2020.
(60) Provisional application No. 63/069,471, filed on Aug. 24, 2020.

(51) Int. Cl. C01B 3/38; B01J 23/83; B01J 23/10; B01J 23/00; B01J 23/755; B01J 35/02

(52) U.S. Cl. CPC C01B 3/38; B01J 23/83; B01J 23/10; B01J 23/002; B01J 23/755; B01J 35/023; C01B 2203/0238; C01B 2203/1614

(57) ABSTRACT

Provided herein are catalyst materials and processes for processing hydrocarbons. For example, doped ceria-supported metal catalysts are provided exhibiting good activity and stability for commercially relevant dry reforming of methane as well as mixed hydrocarbon feedstocks under process conditions including low temperature and long term operation. Useful doped ceria-supported metal catalysts include nickel dispersed over Ti-doped ceria.

### CROSS-REFERENCE TO RELATED APPLICATIONS

This application claims priority to U.S. Provisional Patent Application No. 63/169,997, filed Apr. 2, 2021 and is a continuation in part of U.S. patent application Ser. No. 17/082,406 filed Oct. 28, 2020, which claims the benefit of priority to U.S. Provisional Patent Application Nos. 62/927,518 filed Oct. 29, 2019, 62/957,962 filed Jan. 7, 2020, and 63/069,471, filed Aug. 24, 2020, each of which is hereby incorporated by reference in their entireties to the extent not inconsistent herewith.

### STATEMENT REGARDING FEDERALLY SPONSORED RESEARCH OR DEVELOPMENT

This invention was made with government support under Grant no.: CHE 1151846 awarded by the National Science Foundation. The government has certain rights in the invention.

### BACKGROUND OF INVENTION

The demand for energy continues to increase due to the rapid rise of the world's population and industrial development. This is coinciding with the use of non-renewable traditional fossil fuels and related production of greenhouse gases with potential environmental impacts. Therefore, it is important to manage all energy sources to fulfill the energy demand of society, while addressing environmental concerns around the production of greenhouse gases.

Dry reforming of methane (DRM, CH₄+CO₂→2CO+2H₂; ΔH_{298 K}=+247 kJ/mol) is one of the potential solutions that mitigate and consume two greenhouse gases (CO₂ and CH₄) to produce industrially important syngas (CO and H₂). (Pakhare, D., Spivey, J., A Review of Dry (CO₂) Reforming of Methane over Noble Metal Catalysts. Chemical Society Reviews, 2014, 43, (22), 7813-7837.) The syngas is utilized to produce liquid fuels, ammonia/urea production, and other chemicals. DRM processes produce the syngas of H₂: CO with a molar ratio closer to 1, which increases the affinity and selectivity for producing liquid hydrocarbons using the Fischer-Tropsch process.

There has been a significant growing interest in the DRM technology owing to: (1) the environmental concerns associated with large-scale CO₂ emissions and (2) the ability to competitively produce chemicals, fuels, and other engineered products. With the growth of the natural gas industry in the US as well as around the world, natural gas that is methane-enriched is cheap, abundant, and expected to become more so into the future. The recognized social cost of DRM includes mitigating CO₂ release that otherwise might be emitted into the atmosphere, together with the requirement not to need substantial volumes of water to manage the CO₂ processed; which is the case of alternative other reforming technologies such as steam methane reforming and auto-thermal reforming. Water can be a scarce resource. These attributes make DRM a very appealing technology solution in industrial applications that are divorced from carbon dioxide infrastructure and direct utilization applications such as for storage and enhanced oil recovery. Industries without such convenient and cheap carbon dioxide disposition management infrastructure options such as petrochemicals, crude oil refineries, and steel making, release huge volume of CO₂ into the atmosphere. Therefore, the application of DRM technology is a compelling CO₂ management solution for these manufacturing sites, especially as natural gas is locally available to them.

Compared to other reforming processes (e.g. steam reforming of methane), the proportional consumption of CO₂ and methane in DRM could reduce the overall carbon footprint of a production facility. Recognizing that industries are now being increasingly regulated to mitigate CO₂ emissions, and in the future there may well be scope to possibly attract tax credits associated with carbon dioxide abatement, making the DRM route compelling. (Internal Revenue Code Tax Fact Sheet. Department of Energy, Fossil Energy, October 2019 and Ross, J. R. H., Natural Gas Reforming and CO2 Mitigation. Catalysis Today, 2005, 100, (1-2), 151-158). Studies have shown that the use of DRM for industrial processes that contain both methane and CO₂ could lower the overall operation cost by 20% compared to other reforming reactions.

Conventional DRM catalytic processes are typically carried out in the presence of a heterogeneous catalyst and oftentimes require high reaction temperatures. Catalysts for

DRM include noble metals (e.g., Pt, Rh, and Ru) that exhibit high reactivity but are expensive to practically implement on a commercial scale. A class of Ni-based catalysts have also been investigated for DRM that exhibit reasonable activity, stability and are less expensive than the corresponding noble metal catalysts (Bardford, M. C., Vannice, M. A., Catalytic Reforming of Methane with Carbon Dioxide over Nickel Catalysts I. Catalyst Characterization and Activity. Applied Catalysis A, 1996, 142, 73-96). They are subjective to catalyst deactivation due to sintering and coke formation at high reaction temperatures in DRM processes.

As will be evident from the foregoing, new catalytic materials and processes are needed for DRM to realize the benefits of large scale adoption of the DRM technology. Specifically, improved catalytic materials for DRM are needed that are capable of good activity at low temperatures, high thermal stability, and that are economical to commercialize.

### SUMMARY OF THE INVENTION

Provided herein are catalyst materials and processes for processing hydrocarbons. For example, doped ceria-supported metal catalysts are provided exhibiting good activity and stability for commercially relevant DRM process conditions including long-term operation.

In an aspect, catalysts and catalytic processes are provided for the production of a syngas product. For example, methods and catalyst materials are provided for dry reforming of methane, and optionally other hydrocarbons, for the production of a syngas product. Methods of the invention also include catalysts and methods for efficient processing of hydrocarbon-containing feedstocks, including exhausts and other byproducts, derived from important industrial processes.

In an aspect, methods for processing a hydrocarbon feedstock are provided, the method comprising the step of: contacting a feedstock with a doped ceria-supported metal catalyst comprising a mixed oxide support and an active metal, thereby generating a product comprising H₂ and CO; wherein the doped ceria-supported metal catalyst is of the formula (FX1):

M/Ce₁₋ₓBₓO_{2-δ} (FX1);

wherein M is one or more metals selected from Ni, Co, Pd, Rh, and Pt or a mixture thereof; B is one or more dopants selected from Ti, Zr, Mn, and La; x is a number selected from the range of 0.05 to 0.5 and wherein δ represents oxygen deficiency; and wherein the feedstock comprises methane with one or more additional hydrocarbon components and CO₂, wherein optionally the weight percent of said one or more metals in the catalyst is selected from the range of 0.1-20 wt. %, optionally for some embodiments 1.5-7 wt. % and optionally for some embodiments 2.0-3 wt. %, and/or optionally the ratio of Ce to B is selected from the range of 0.1 to 10, optionally for some embodiments selected from the range of 1 to 3. In an embodiment of this aspect, the process is for production of a syngas product, for example, via a DRM process. In an embodiment, the feedstock is obtained or derived from an industrial process that generates both carbon dioxide and methane. In an embodiment, the feedstock is obtained or derived from an industrial process that generates carbon dioxide, and optionally is in close proximity to a source of methane.

In an aspect, methods for processing a hydrocarbon feedstock are provided, the method comprising the steps of: contacting a feedstock with a doped ceria-supported metal catalyst comprising a mixed oxide support and an active metal, thereby generating a product comprising H₂ and CO; wherein the doped ceria-supported metal catalyst is of the formula (FX1):

M/Ce₁₋ₓBₓO_{2-δ} (FX1);

wherein M is one or more metals selected from Ni, Co, Pd, Rh, and Pt or a mixture thereof; B is one or more dopants selected from Ti, Zr, Mn, and La; x is a number selected from the range of 0.05 to 0.5 and wherein δ represents oxygen deficiency; and wherein the feedstock comprises methane and CO₂; wherein the feedstock is a byproduct from cement processing, steel processing, coal refining, petrochemical refining, crude oil production, natural gas production, coal mining or minerals mining, such as a product or exhaust (including a processed process or exhaust) from any of these processes. In an embodiment of this aspect, the process is for production of a syngas product, for example, via a DRM process, wherein optionally the weight percent of said one or more metals in the catalyst is selected from the range of 0.1-20 wt. %, optionally for some embodiments 1.5-7.0 wt. % and optionally for some embodiments 2.0-3.0 wt. %, and/or optionally the ratio of Ce to B is selected from the range of 0.1 to 10, optionally for some embodiments selected from the range of 1 to 3.

In an aspect, metal supported on doped ceria catalysts are provided, comprising metal particles dispersed over mixed dopant-ceria supports. In an embodiment, for example, a catalyst comprises a doped ceria-supported metal of the formula (FX1): M/Ce₁₋ₓBₓO_{2-δ (FX}1); wherein M is one or more metals selected from Ni, Co, Pd, Rh, and Pt or a mixture thereof; B is at least two dopants selected from Ti, Zr, Mn and La; x is a number selected from the range of 0.05 to 0.5 and wherein δ represents oxygen deficiency; wherein optionally the weight percent of said one or more metals in the catalyst is selected from the range of 0.1-20 wt. %, optionally for some embodiments 1.5-7 wt. % and optionally for some embodiments 2.0-3.0 wt. %, and/or optionally the ratio of Ce to B is selected from the range of 0.1 to 10, optionally for some embodiments selected from the range of 1 to 3. In an embodiment of this aspect, the catalyst is for processing a hydrocarbon feedstock, for example, via a DRM process.

The present catalysts and process are compatible with a variety of hydrocarbon feedstocks. The ability to process mixed feedstocks provides flexibility with respect to a wide range of the industrial applications that the present catalysts and process may be effectively integrated. In some embodiments, the hydrocarbon feedstock comprises methane and CO₂, optionally in combination with other feedstock components such as other hydrocarbons and/or none hydrocarbon components. In an embodiment, for example, the hydrocarbon feedstock comprises methane, CO₂, with one or more of ethane, propane, or other hydrocarbons. In an embodiment, the hydrocarbon feedstock is natural gas or derived from natural gas.

The present catalysts and process are well suited for processes involving a feedstocks derived from exhaust or emission sources, for example, originating from a range of industrial processes. In an embodiment, the hydrocarbon feedstock is derived from a processing involving production, processing, treatment or combustion of a hydrocarbon fuel such as a petrochemical fuel, natural gas or coal, or of a mining product such as coal or minerals. In an embodiment, the hydrocarbon feedstock comprises a product, such as an exhaust or byproduct, from one or more processes selected from the group of: a coal pyrolysis process; a petrochemical oxidization process; a sintering process; a furnace process; a kiln process; a steam reforming process; an ammonia production process; a fuel production or treatment process, a mining process and virtually any process that produces carbon dioxide. In some embodiments, the hydrocarbon feedstock is derived from an exhaust or other byproduct that has been treated prior to contact with the DRM catalyst, for example, to remove at least a portion of sulfur and/or nitrogen containing species, such as SOₓ and NOₓ gases, and or particulate, such as soot. In some embodiments, the hydrocarbon feedstock is CO₂ and methane (and/or other hydrocarbons) originating from the same industrial source or industrial process. In some embodiments, the hydrocarbon feedstock is CO₂ and methane (and/or other hydrocarbons) originate from different industrial sources or industrial processes located proximate to each other, such as close enough to allow for technically and/or commercially feasible (or attractive) dry reforming of methane using the present methods.

Catalyst if the invention include heterogeneous catalysts, for example including multicomponent catalysts having an active metal particulate component supported by an active support component. Catalysts may comprise metal supported on doped ceria. In some embodiments, doped ceria is the support, which contains dopants like Ti and others, and metals like Ni can be dispersed over the support of doped ceria. In embodiments, for example, the metal may be in an active form of Ni, Co or Pd and, optionally mixtures of these metals. In an embodiment, the metals anchor and/or are disposed over catalytic supports such as ceria or doped ceria. The present processes and catalysts include a class of metal supported on doped ceria catalysts characterized by a range of chemical components and relative amounts of each chemical component.

In an embodiment, for example, the doped ceria-supported metal catalyst comprises the one or more metals dispersed over a doped catalyst support characterized by the formula Ce₁₋ₓBₓO_{2-δ}, wherein M is one or more metals selected from Ni, Co, Pd, Pt or a mixture thereof; B is one or more dopants selected from Ti, Zr, Mn, and La; x is a number selected from the range of 0.05 to 0.5 and wherein δ represents oxygen deficiency. In an embodiment, the doped catalyst support maintains the structure of pure ceria and produces mixed metal oxides.

In an embodiment, the one or more metals of the catalyst are provided as particles or clusters, for example, particles having an average size dimension (e.g. diameter, effective diameter, etc.) up to 1 micron, optionally up to 500 nm, optionally up to 100 nm and optionally up to 30 nm. In an embodiment, the weight percent of the one or more metals in the catalyst is selected from the range of 0.1-20 wt. %, optionally for some embodiments 0.5-10 wt. %, optionally for some embodiments 1-5 wt. %, optionally for some embodiments 2.0 — 3.0 wt. %, and optionally for some embodiments 1.5-2.5 wt. %.

Catalysts and catalytic processes may include metal supported on doped ceria materials including an active component comprising Ni metal particulate. In an embodiment, the one or more metals in formula (FX1) is Ni; and wherein Ni has a weight percent in the catalyst selected from the range of 0.5-10 wt. %, optionally for some embodiments 1.5-7.0 wt. %, optionally for some embodiments 2.0 — 3.0 wt. %, optionally for some embodiments 1.5-2.5 wt. %. In an embodiment, for example, the one or more metals in formula (FX1) is Ni; and Ni has a weight percent in the catalyst of 2.4±0.5%.

Catalysts and catalytic processes may include metal supported on doped ceria materials including an active component comprising a doped ceria support. In an embodiment, the ratio of Ce to B in formula (FX1) selected from the range of 0.1 to 10, optionally 0.2 to 5 and optionally 1 to 5 and optionally 1 to 3. In an embodiment, the one or more dopants (B) in formula (FX1) is Ti, wherein the ratio of Ce to Ti is selected form the range of 1.5 to 3.0, optionally 2.0 to 2.7. In an embodiment, for example, the one or more dopants (B) in formula (FX1) is Ti, wherein the ratio of Ce to Ti is 2.3±0.3.

Catalysts and catalytic processes may include metal supported on doped ceria materials including an active component comprising a doped ceria support having at least two different dopants. In an embodiment, for example, the catalyst is of formula (FX1) wherein the one or more dopants is at least two different dopant materials, such as Ti and at least one other dopant selected from Zr, Mn, and La. In an embodiment, for example, the catalyst is of formula (FX1) wherein the one or more metals is Ni; wherein the weight percent of Ni in the catalyst is selected from the range of 1.5-2.5 wt. %, optionally 2±0.3%; and wherein the ratio of Ce to Ti is selected form the range of 2.0 to 2.7.

The present catalysts may also be characterized by physical properties. In an embodiment, for example, the doped ceria-supported metal catalyst is characterized by a BET surface area selected from the range of 10 m² g⁻¹ to 100 m² g⁻¹.

The present catalysts may be prepared using a variety of techniques. In an embodiment, the doped ceria-supported metal catalyst is produced by one or more processes selected from sol-gel technique, calcination, wet impregnation, or any combination of these. In an embodiment, the doped ceria-supported metal catalyst is produced by sol-gel technique. In an embodiment, the doped ceria-supported metal catalyst is calcined. In an embodiment, the one or more metals is provided via wet impregnation to generate the doped ceria-supported metal.

Catalytic processes of the invention are versatile with respect to process conditions providing effective hydrocarbon processing, including MRP processing, including providing high conversion and product yields at lower reaction temperatures and for long operating periods. In an embodiment, the step of contacting said mixed feedstock with a doped ceria-supported metal catalyst is carried out at a temperature equal to or greater than 600° C., optionally equal to or greater than 650° C., optionally equal to or greater than 700° C., and optionally equal to or greater than 750° C. In an embodiment, the step of contacting said mixed feedstock with a doped ceria-supported metal catalyst is carried out at a temperature selected over the range of 600° C. to 800° C. In an embodiment, the step of contacting the mixed feedstock with a doped ceria-supported metal catalyst is capable of generating the product, such as a syngas product, at a temperature less than or equal 350° C.

In an embodiment, the method is characterized by a methane conversion efficiency equal to or greater than 70% at a temperature of 650° C. or greater. In an embodiment, the method is characterized by a ratio of H₂ produced to CO produced equal to or greater than 90% at a temperature of 650° C. or greater.

In an embodiment, the hydrocarbon feedstock comprises methane, ethane and propane. In the embodiment, the method may be characterized by: a methane conversion efficiency equal to or greater than 60% at a temperature of 750° C. or greater; an ethane conversion efficiency equal to or greater than 90% at a temperature of 750° C. or greater; and a propane conversion efficiency equal to or greater than 90% at a temperature of 750° C. or greater.

In an embodiment, the doped ceria-supported metal catalyst is stable over a reaction time of at least 50 hours. In an embodiment, there is any of the methods above, wherein the doped ceria-supported metal catalyst does not undergo appreciable degradation over a reaction time of at least 50 hours. In an embodiment, the step of contacting the mixed feedstock with a doped ceria-supported metal catalyst is carried out a pressure selected from the range of 0.1 Bar to 2 Bar and a temperature selected from the range of 25° C. to 800° C.

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

### BRIEF DESCRIPTION OF THE DRAWINGS

FIGS. 1A-1H. Scanning tunneling microscopy images of pure CeO₂ (FIG. 1A), Ni nanoparticles deposited on CeO₂ (FIG. 1B), Ti-doped CeO_{1.8} (FIG. 1C) as well as Ni dispersed on Ti-doped CeO_{1.8}. All catalytic surfaces were annealed to 800 K. Low energy electron diffraction pattern shows the ceria support is ordered exhibiting the (111) plane. Higher resolution image (3×3 nm²) shown as an inset in FIG. 1A resolves the individual Ce atoms on the CeO₂(111) surface. FIGS. 1E and 1F. Temperature programmed desorption studies show reaction products collected from Ni/CeO_{1.8} and Ni/Ti—CeO_{1.8} surfaces upon dose of 2 Langmuir ethanol at 300 K with heating to 800 K. C1s X-ray photoelectron spectroscopy peaks collected upon ethanol adsorption over indicated surfaces at 300 K and heating to higher temperatures (FIGS. 1G and 1H).

FIG. 2A. CH₄ and CO₂ conversions and CO and H₂ yields for 2 wt. % Ni/Ce_{0.7}Ti_{0.3}O_{2-δ} for dry reforming of methane reaction based on the gas chromatography analysis. FIG. 2B. Partial pressure values of CH₄, CO₂, CO and H₂ monitored by a mass spectrometer during the DRM reaction with a temperature range between 100 and 800° C. over 2 wt. % Ni/Ce_{0.7}Ti_{0.3}O_{2-δ}. FIG. 2C. The DRM stability test for 2 wt. % Ni/Ce_{0.7}Ti_{0.3}O_{2-δ} at indicated temperatures. FIG. 2D. Comparison results for the DRM stability test for Ni, Pd, and Co.

FIG. 3A. XRD patterns collected from as-prepared samples of CeO₂ (I), Ce_{0.9}Ti_{0.1}O_{2-δ} (II), Ce_{0.8}Ti_{0.2}O_{2-δ} (III), Ce_{0.7}Ti_{0.3}O_{2-δ} (IV), Ce_{0.6}Ti_{0.4}O_{2-δ} (V), and Ce_{0.5}Ti_{0.5}O_{2-δ} (VI); (FIG. 3B) XRD patterns of nominal 3.0 wt. % Ni dispersed over various supports as indicated in (a); (FIG. 3C) spent samples of nominal 3.0 wt. % Ni dispersed on CeO₂ (I), Ce_{0.7}Ti_{0.3}O_{2-δ} (II), and Ce_{0.5}Ti_{0.5}O_{2-δ} (III); SEM images of as-prepared samples of CeO₂ (FIG. 3D), Ce_{0.7}Ti_{0.3}O_{2-δ} (FIG. 3E), 2.4 wt. % Ni/Ce_{0.7}Ti_{0.3}O_{2-δ} (FIG. 3F), as well as spent samples of 2.4 wt. % Ni/Ce_{0.7}Ti_{0.3}O_{2-δ} after the DRM reaction on stream for 0.5 h (FIG. 3G) and 50 h (FIG. 3H).

FIGS. 4A-4F. Temperature-dependent DRM data of CH₄ conversion (FIG. 4A), CO₂ conversion (FIG. 4B), H₂ yield (FIG. 4C), and CO yield (FIG. 4D) for nominal 3.0 wt. % Ni dispersed over CeO₂, 2.4 wt. % Ni/Ce_{0.7}Ti_{0.3}O_{2-δ}, and nominal 3.0 wt. % Ni/Ce_{0.5}Ti_{0.5}O_{2-δ}; DRM data for Ce_{0.7}Ti_{0.3}O_{2-δ} and thermodynamic equilibrium data for DRM assuming no carbon formation occurs [1] are shown for comparisons in FIGS. 4A-4D; (FIG. 4E) H₂/CO ratios of indicated catalysts in FIGS. 4A-4D and thermodynamic equilibrium data; (FIG. 4F) calculated amounts of CH₄, CO₂, H₂, and CO for 2.4 wt. % Ni/Ce_{0.7}Ti_{0.3}O_{2-δ}. The wt. % value indicated for 2.4 wt. % Ni/Ce_{0.7}Ti_{0.3}O_{2-δ} was confirmed by inductively coupled plasma.

FIGS. 5A-5D. XRD patterns of (FIG. 5A) as-prepared samples and (FIG. 5B) spent samples of Ni/Ce_{0.7}Ti_{0.3}O_{2-δ} with the Ni loading of 0.0 wt. % (I), 0.5 wt. % (II), 1.2 wt. % (III), 2.4 wt. % (IV), 4.0 wt. % (V), and 10.8 wt. % (VI); (FIG. 5C) the conversions of CO₂ and CH₄ and (FIG. 5D) the yields of CO and H₂ of indicated catalysts at 650 and 750° C. in DRM.

FIG. 6A. CO₂ and CH₄ conversions and (FIG. 6B) CO and H₂ yields from the DRM stability test at 650° C. for 25 hours for 2.4 wt. % Ni/Ce_{0.7}Ti_{0.3}O_{2-δ} and 3.1 wt. % Ni/CeO₂.

FIGS. 7A-D. Temperature-dependent DRM data of CH₄ conversion (FIG. 7A), CO₂ conversion (FIG. 7B), H₂ yield (FIG. 7C), and CO yield (FIG. 7D) for nominal 5.0 wt. % Ni dispersed over Ce_{0.5}Ti_{0.5}O_{2-δ}. The samples were reduced in 20 mL min⁻¹ H₂ for one hour prior to the DRM reactivity test. One sample was reduced in H₂ at 400° C. and the other sample was reduced in H₂ at 550° C. The DRM activity data were compared with respect two different reduction temperatures.

FIG. 8. XRD patterns of as-prepared Ce_{0.9}Ti_{0.1}O_{2-δ} and nominal 5 wt. % Ni dispersed over Ce_{0.9}Ti_{0.1}O_{2-δ}.

FIG. 9A. CH₄, C₂H₆, C₃H₈, and CO₂ conversions as well as CO and H₂ yields for a selected Ni catalyst supported on Ti-doped ceria (nominal 5 wt. % Ni/Ce_{0.9}Ti_{0.1}O_{2-δ}) for dry reforming of a mixed C1-C3 hydrocarbons based on the gas chromatography analysis. The composition of the reaction gas mixture is shown in Table 1. 100 mg of the sample, a nominal flow rate of 20 ml min⁻¹ of the reaction mixture, and 5 ml min⁻¹ nitrogen as an internal standard were used. FIG. 9B. CH₄ and CO₂ conversions and CO and H₂ yields for dry reforming of methane over nominal 5 wt. % Ni/Ce_{0.9}Ti_{0.1}O_{2-δ} based on the gas chromatography analysis. 100 mg of the sample, a nominal flow rate of 10 ml min⁻¹ for methane and CO₂, and 5 ml min⁻¹ nitrogen as an internal standard were used.

FIG. 10. CH₄, C₂H₆, C₃H₈, and CO₂ conversions as well as CO and H₂ yields for a selected Ni catalyst supported on Ti-doped ceria (nominal 5 wt. % Ni/Ce_{0.9}Ti_{0.1}O_{2-δ}) for dry reforming of a mixed C1-C3 hydrocarbons at 750° C. based on the gas chromatography analysis. The composition of the reaction gas mixture is shown in Table 1. 100 mg of the sample, a nominal flow rate of 20 ml min⁻¹ of the reaction mixture, and 5 ml min⁻¹ nitrogen as an internal standard were used.

FIG. 11. Temperature-dependent data of reactant species and products collected upon flowing the reaction gas mixture shown in Table 1 through the reactor with no catalyst. A nominal flow rate of 40 ml min⁻¹ of the reaction mixture and 10 ml min⁻¹ nitrogen as an internal standard were used.

FIG. 12A shows comparisons of hydrocarbon conversions obtained from individual runs of dry reformation of methane, ethane, and propane using a nominal 5 wt. % Ni/Ce_{0.9}Ti_{0.1}O₂ catalyst. The data were collected using an on-line Hiden HPR-20 ambient pressure mass spectrometer.

FIG. 12B shows comparisons of carbon dioxide conversions obtained from individual runs of dry reformation of methane, ethane, and propane using a nominal 5 wt. % Ni/Ce_{0.9}Ti_{0.1}O₂ catalyst. The data were collected using an on-line Hiden HPR-20 ambient pressure mass spectrometer.

### STATEMENTS REGARDING CHEMICAL COMPOUNDS AND NOMENCLATURE

In general, the terms and phrases used herein have their art-recognized meaning, which can be found by reference to standard texts, journal references and contexts known to those skilled in the art. The following definitions are provided to clarify their specific use in the context of the invention.

The expressions “doped ceria-supported metal catalyst” and “metal supported on doped ceria catalysts” are used interchangeably and refer to a material comprising a metal provided on and/or within a doped ceria support. In embodiments, the metal is dispersed over the doped ceria support, for example, provided as particles or clusters on internal and/or external surfaces of the doped ceria support. Metals useful for the present on doped ceria-supported metal catalysts include Ni, Co, Pd, Rh, and Pt or any mixtures thereof. The doped ceria support includes one or more metal dopants incorporated into the lattice of ceria, optionally including two or more different metals. Dopants useful for the present doped ceria-supported metal catalysts include Ti, Zr, Mn, La and any mixtures thereof. In an embodiment, doped catalyst support maintains the structure of pure ceria and produces mixed metal oxides. Doped ceria-supported metal catalysts may exhibit catalytic activity for processing of a hydrocarbon feedstock, for example, in a DRM process.

The expression “hydrocarbon feedstock” refers to feedstocks for a process, such as a catalytic process, that include at least one hydrocarbon component. Hydrocarbon feedstocks for some embodiments comprise a hydrocarbon component and CO₂. Hydrocarbon feedstocks for some embodiments comprise methane and CO₂. Hydrocarbon feedstocks for some embodiments comprise methane, CO₂, with one or more other hydrocarbons. Hydrocarbon feedstock may be characterized in terms of the ratio of methane to CO₂ and or ratio of other hydrocarbons to CO₂. When discussing feedstock, applicants note that the source of hydrocarbon can be separate from the source of CO₂ feed, for example, to allow ratio to be varied and/or controlled. Components of feedstock, such as CO₂ and methane, can be separately introduced into catalytic reactor or added as a mixture. Optionally, CO₂ level can be adjusted in a hydrocarbon feedstock, etc. This will depend on feedstock and catalyst. Hydrocarbon feedstocks for some embodiments comprise methane, ethane, and propane. Hydrocarbon feedstocks for some embodiments comprise ethane, propane, or butane. Hydrocarbon feedstocks for some embodiments include natural gas or a derivative thereof. Also, feedstock can be from one or more industrial synthesis, production, manufacturing and/or treatment processes including cement processing, steel processing, coal refining, petrochemical refining, crude oil production, natural gas production, coal mining and/or minerals mining. Hydrocarbon feedstocks for some embodiments comprise comprises a product of an industrial process or a combination of products from one or more industrial processes. Hydrocarbon feedstocks for some embodiments comprise an exhaust or byproduct gas, for example, from a coal pyrolysis process; a petrochemical oxidization process; a sintering process; a furnace process; a kiln process; a steam reforming process; an ammonia production process; and any process that produces carbon dioxide. In an embodiment, the hydrocarbon feedstock is obtained or derived from an industrial process that generates both CO₂ and methane. In an embodiment, the hydrocarbon feedstock is obtained or derived from an industrial process that generates or emits carbon dioxide, and optionally is in proximity to a source of methane, such as within 100 miles, optionally 50 miles and optionally 20 miles, of each other. In an embodiment, the hydrocarbon feedstock includes CO₂ derived from an industrial process involving production, refining, treatment or combustion of a fuel, such as coal, natural gas or oil. Hydrocarbon feedstocks may be treated prior to contact with the present catalysts to remove, add or enrich certain feedstock components. In an embodiment, for example, a hydrocarbon feedstock is treated for removal of sulfur components (SOₓ), nitrogen components (NOₓ), water and/or particulate (e.g., carbonaceous particulate such as soot). Often processes of the invention are continuous with feedstock continuously added and product removed, but the present processes also include a batch process.

The symbol “δ” represents oxygen deficiency. In some examples, the numeric value of δ ranges from greater than 0 to less than 0.5.

The word “nominal” in nominal wt. % refers to the theoretical/anticipated value of the amount of Ni based on a calculation, for example, using parameters from and/or during the materials synthesis. In some embodiments, the wt. % values are examined analytically, such as by ICP analysis, wherein such wt. % values are reported without the word “nominal”. The ICP analysis of Ni may be carried out by dissolving the materials in aqua regia at 60° C. followed by the analysis of the Ni amount in the solution and by other techniques generally known in the art.

In an embodiment, a composition or compound of the invention, such as a composite, metal, alloy, metal oxide, precursor, or catalyst, is isolated or substantially purified. In an embodiment, an isolated or purified compound is at least partially isolated or substantially purified as would be understood in the art. In an embodiment, a substantially purified composition, compound or formulation of the invention has a chemical purity of 95%, optionally for some applications 99%, optionally for some applications 99.9%, optionally for some applications 99.99%, and optionally for some applications 99.999% pure.

### DETAILED DESCRIPTION OF THE INVENTION

In the following description, numerous specific details of the devices, device components, and methods of the present invention are set forth in order to provide a thorough explanation of the precise nature of the invention. It will be apparent, however, to those of skill in the art that the invention can be practiced without these specific details.

The demand for energy is continuing to increase due to the rapid rise of the world's population and industrial development. This is coinciding with the use of non-renewable traditional fossil fuels. Therefore, it is ideal to find alternative energy sources to fulfill the energy demand of our modern society. Dry reforming of methane is one of the potential reactions that utilize CO₂ and CH₄ to produce industrially important syngas. Syngas is further utilized to produce fertilizer and/or synthetic petroleum as fuels or chemicals. Generally, this reaction is carried out at high reaction temperatures in the presence of a heterogeneous catalyst. However, our current global goal for the DRM reaction is to develop thermally stable and active catalysts at reduced reaction temperatures, which can show good resistance to deactivation. Ni (and other metals) dispersed over a range of Ti-doped ceria catalysts were examined in our study and found to be effective and stable for the dry reforming of methane, ethane, and propane.

Technical Description:

Ce₁₋ₓTiₓO_{2-δ} supported Ni, Co, and Pd catalysts were synthesized with Ti concentrations (including x=0.1, 0.2, 0.3, 0.4, and 0.5) with controlled metal loadings between 1 and 10 wt. % by a sol-gel technique and characterized with x-ray diffraction (XRD), scanning electron microscopy-energy dispersive spectroscopy, BET surface area, inductively coupled plasma (ICP), and hydrogen chemisorption. XRD shows the formation of Ce₁₋ₓTiₓO_{2-δ} solid materials for selected Ce:Ti composition ratios. Ceria exhibits unique redox properties and oxygen storage capacities, which can better anchor Ni as small clusters and inhibit coke formation. Introduction of metal dopant, Ti, into ceria could promote its redox properties as well as enhance its thermal stability at high temperatures.

Nanoparticles of Ni (or Co and Pd) are dispersed over the Ce₁₋ₓTiₓO_{2-δ} support surface. The catalytic DRM performance was investigated in a continuous gas flow reactor using gas chromatography and mass spectrometry instruments and compared with respect to reaction temperatures, Ce:Ti ratios in the oxide supports, and Ni weight loadings. XRD data show the formation of Ce₁₋ₓTiₓO_{2-δ} solid mixed oxide supports. Reactivity was examined with respect to key factors such as: Ce:Ti ratio, reaction temperature, metal (Ni, Co, or Pd), metal loading, reactant composition, and alkane species (methane, ethane, propane). This work demonstrates the DRM activity depends on the Ce:Ti composition in the support and the metal loading of the Ni. The 2±0.3 wt. % Ni supported on Ce₁₋ₓTiₓO_{2-δ} catalyst shows the remarkable CH₄ conversion and hydrogen yield at temperatures as low as 600° C. Additionally the catalysts exhibit little activity loss over a 50-hour reaction period compared to other supports. The support also minimizes activity loss for other metals (Co and Pd) and for other feedstocks (ethane and propane).

The 2 wt. % Ni/Ce_{0.7}Ti_{0.3}O_{2-δ} catalyst was identified to deliver the good catalytic activity and stability among all the ceria supports and Ni loadings examined. At 650° C., the 2 wt. % Ni over Ce_{0.7}Ti_{0.3}O_{2-δ} catalyst shows good conversions of 73% and 79% for CH₄ and CO₂, respectively. The product yields were 42% and 52% for H₂ and CO. Additionally, compared to other metals including Pd and Co, the Ni catalyst delivers a higher reactivity and a long-term stability (up to 50 h) during the DRM reaction on stream. The enhanced reactivity and stability of this catalyst can be attributed to the unique interaction between the Ni metal and Ce_{0.7}Ti_{0.3}O_{2-δ} support, the high BET surface area (26 m² g⁻¹) and metal active sites.

This example demonstrates the DRM activity depends on the Ce:Ti composition in the support and the metal loading of the Ni. The 2 wt. % Ni supported on Ce₁₋ₓTiₓO_{2-δ} catalyst shows the remarkable CH₄ conversion and hydrogen yield at temperatures as low as 600° C. Additionally, the catalyst exhibits little activity loss over a 50 hour reaction period compared to other supports. The support also minimizes activity loss for other metals (Co and Pd) and for other feedstocks (ethane and propane). Overall this study of the catalyst with three metals (Ni, Co, and Pd) and multiple feedstocks (methane, ethane, and propane) over a series of Ce₁₋ₓTiₓO_{2-δ} supports indicates an active and stable catalyst for dry reforming and have significant applicability for a range of industrial applications. Prior to the DRM activity test, all catalysts were reduced in H₂ with a flow rate of 20 mL min⁻¹ for one hour.

Dry reforming of methane was carried out in a fixed-bed continuous flow reactor that is made up of a quartz glass with an internal diameter of 0.25 inch and a length of 24 inches. The catalyst amount of 200 mg was used. Flow rates of 12.5 mL min⁻¹ of methane and 12.5 mL min⁻¹ of carbon dioxide were used for the dry reforming of methane reaction, yielding a total flow rate of 25 mL min⁻¹ for the mixture. GHSV of 5098 h⁻¹ is determined based on the catalyst bed volume of 0.294 cm³. Catalytic tests were performed at temperatures ranging from 25 to 800° C. with a 30-minute reaction duration. Flow rates of 8.3 mL min⁻¹ of ethane and 16.7 mL min⁻¹ of carbon dioxide were used for the dry reforming of ethane reaction, yielding a total flow rate of 25 mL min⁻¹ for the mixture. The catalyst amount of 300 mg was used. Flow rates of 5 mL min⁻¹ of propane and 20 mL min⁻¹ of carbon dioxide were used for the dry reforming of propane reaction, yielding a total flow rate of 25 mL min⁻¹ for the mixture. The catalyst amount of 200-300 mg was used.

Advantages: (1) The present catalysts and processes activate the DRM reaction between 300 and 350° C. (2) The present catalysts and processes provide an outstanding CH₄ conversion of 73% at 650° C. and close to 100% CH₄ conversion at 800° C. with primarily CO and H₂ products. (3) The present catalysts are stable for a 50 hour reaction run. (4) The catalysts are also effective at dry reforming of ethane and propane. (5) The Ce₁₋ₓTiₓO_{2-δ} support is capable of minimizing catalyst deactivation for Ni, Co, and Pd. Reactant conversions and product yields for dry reforming have been enhanced.

The invention can be further understood by the following non-limiting examples.

### EXAMPLE 1

### Multi-Functional Ceria-Supported Ni Catalysts for Dry Reforming of Methane

This Example relates to ceria promoted Ni catalysts for application in dry reforming of methane to produce syngas (CO and H₂) for industrial applications, to produce hydrogen as energy fuels, and contribute to a reduction in CO₂ emissions. Ni is active towards CH₄ activation in DRM. However, it can deactivate easily due to thermal agglomeration and coke formation. Unique redox properties and oxygen storage capacities of ceria can promote the stability of Ni. Furthermore, doping ceria with other metal elements (e.g. Ti, Zr, Mn, and La) not only can enhance its thermal stability at high temperatures, but also cause structural and electronic modifications resulting in enhanced redox properties. This example provides a fundamental mechanistic understanding of the effect of the dopants (e.g. Ti, Zr, Mn, and La) in ceria on the DRM chemistry of Ni. Metal-doped ceria supports are described having controlled structures and compositions for Ni catalysts, along with characterization of their morphology, size, electronic and chemical properties. Advanced techniques may be used to probe various aspects of the catalytic surfaces to establish the interplay between the Ni and ceria support and its effect toward the performance of Ni in the DRM reaction.

Interest in DRM catalysts and processes is driven by the potential conversion of methane with CO₂ to produce fuels and value-added chemicals for the global energy challenge. This work contributes to the long-term goal facing the DRM catalysis that requires the development of economical, efficient and stable multi-functional catalysts. Detailed structure-reactivity mechanistic understanding of ceria promoted Ni catalysts also provides significant insights in the use of Ni-based materials in many other industrial applications. The work establishes new catalyst systems and to obtain data necessary for assessing the scalability and economics of using these catalysts in a hydrogen production facility.

Statement of the problem: The present example focuses on an emerging reaction for the conversion of natural gas to chemical fuels through the dry reforming of methane. DRM utilizes two abundantly available green-house gases to produce industrially important syngas (CH₄+CO₂→2CO+2H₂; ΔH_{298 K}=+247 kJ/mol).¹ There is a growing interest in reacting these two molecules as an efficient way to produce syngas. While DRM is endothermic, its main competition for producing syngas, steam reforming of methane is also +205 kJ/mol exothermic.¹ Since there are extensive proven reserves of natural gas in the United States, methane is likely to remain abundantly available. A study has also indicated that DRM has a 20% lower operating cost compared to other reforming processes.² Syngas can be further used to produce synthetic petroleum as fuels or chemicals. DRM also serves as an important prototype reaction for sustainable chemical recycling and conversion by utilizing a major atmospheric pollutant CO₂.³⁻⁶

DRM involves activation of C—H and C—O bonds followed by subsequent reaction to produce CO and H₂. Metals dispersed on oxides have been used as DRM catalysts.^{1,7-16} The overall activity depends on the type of the active metal, the nature of the support, and the interaction between the metal and support. It is commonly accepted that the reaction mechanism is bifunctional. Methane and CO₂ activate on the metal and support, respectively. The interface between the metal and the metal oxide provides sites to complete the reaction. Supported noble metals including Pt, Rh, and Ru are highly active toward the DRM reaction at high temperatures and more resistant to carbon formation than other transition metals.^{8,10,14} However, they are expensive for practical applications. Ni has also been studied as cheaper and more abundant alternatives.^{9,11,13,16,17} CH₄ can be activated on Ni and undergo thermal decomposition to form H₂ and carbon/CHx/formyl intermediates. Deposited C species can block surface sites on Ni for further reaction. Furthermore, Ni is subjective to sintering which also causes rapid deactivation during reforming reactions.^{18,19} Therefore, a current global challenge for the DRM reaction is to develop thermally stable and active catalysts which can show good resistance to deactivation.

Objectives and approach: This example demonstrates metal-doped ceria as catalytic supports for Ni to address the CO₂ activation as well as the coke issues related with Ni catalysts. One method to suppress coking is to use the oxide support as an oxygen reservoir. Ceria supports provide a solution to improve the stability and catalytic performance of metal catalysts.²⁰⁻⁴¹ Studies have indicated that the catalytic reactivity of ceria-supported metal nanoparticles can be influenced by the redox properties of ceria as well as the synergistic effect between the two.^{23,24} Dispersing metals as nanoparticles on ceria can provide a way to diminish the coke formation. The unique performance of ceria-based catalytic systems have also been related with the ability of ceria to readily transfer its oxidation states between Ce⁴⁺ and Ce³⁺, which facilitates the oxygen release and storage during catalytic reactions.^{25,29,30} Due to unique redox properties and oxygen storage capacity, ceria can act as the active phase to remove C deposit on the metal by oxidation of surface carbon as CO and thus prevent the metal deactivation. The existence of a strong metal-support interaction between metal and ceria may modify the structure and electronic properties of active metals to improve the performance of metal-ceria systems.^{27,41}

Metal-doped ceria in some instances provides a better catalytic support for metal catalysts for practical applications compared to pure ceria. One main issue regarding the use of pure ceria as real-world catalytic supports is its poor thermal stability at high temperatures.^{42,43} It can undergo sintering which causes the loss of its crucial oxygen storage capacity. Not only can doping of ceria with metal elements enhance its thermal stability, but also improve its redox properties and oxygen storage capacity.⁴⁴⁻⁵⁷ The addition of different metal dopants into ceria ideally replaces the Ce cation lattice sites and forms a solid solution of a mixed oxide (Ce₁₋ₓBₓO₂₋₆; B: metal dopant; 0<x<0.5). Due to the size difference between the Ce and the dopant, the doped ceria has non-equivalent metal-oxygen bond distances, and thus a change in its unit cell size, which can weaken the Ce—O and dopant-O bonds resulting in the reduction in the formation energy of oxygen vacancies and promotion of the redox characteristics of Ceria.^{47,48,58} In addition to structural changes, the dopant also introduces electronic modifications of ceria, facilitates the formation of O vacancies on the surface, and increases its redox properties.^{50,59} The enhanced redox properties of doped ceria, due to the structural and electronic modifications by metal dopants, could lead to superior catalytic activity or selectivity of supported metal nanocatalysts.⁶⁰⁻⁷⁰

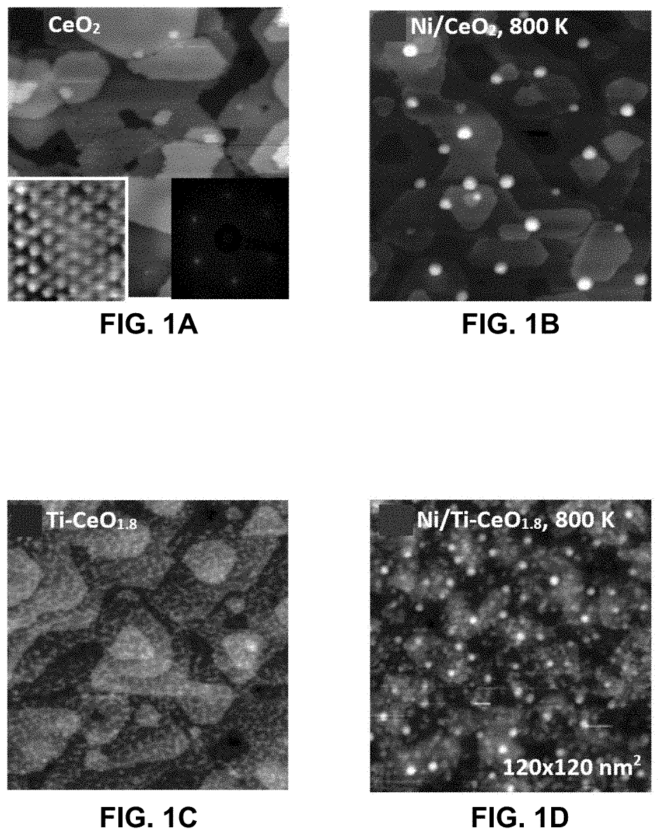

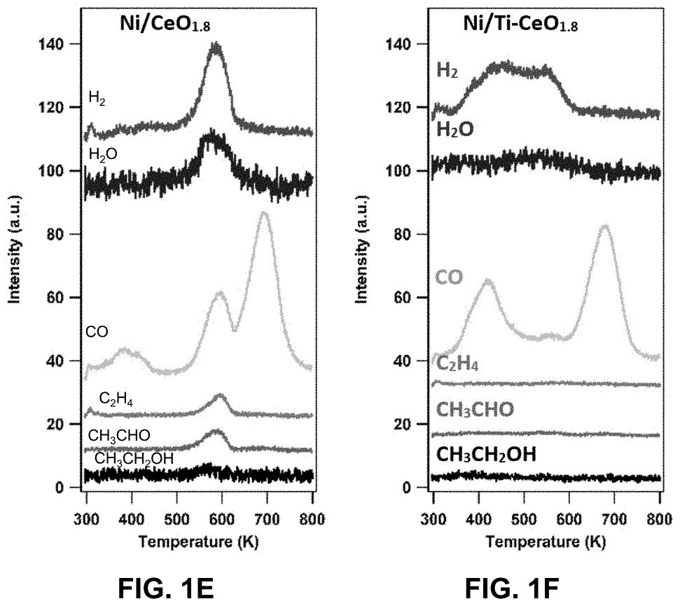

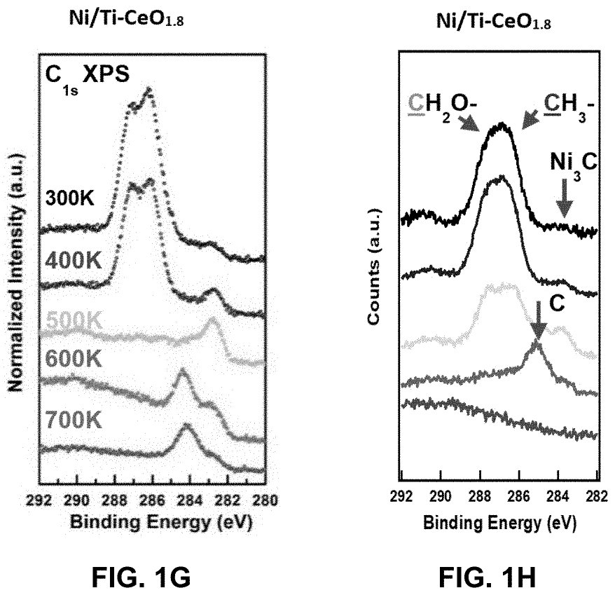

A catalyst composed of Ni particles dispersed on model Ti-doped CeOₓ(111) surfaces (1.5<x<2) is highly active and stable for ethanol adsorption to produce H₂.^{22,71-73} Well-ordered CeOₓ(111) thin films of 2 nm thick grown on Ru(0001) substrate show flat terraces separated by monoatomic steps (FIG. 1A). Doping ceria with Ti can form Ti—O—Ce hetero-structures shown as chain structures on the CeOₓ surface (FIG. 1C). Ni forms three-dimensional particles after heating to 800 K shown as bright protrusions in FIG. 1B. Titania chains on ceria provide the nucleation sites for Ni and greatly inhibit its agglomeration upon heating with significantly smaller Ni particles (FIG. 1D). Modified structural and electronic properties of ceria by Ti can further lead to enhanced reforming activity of deposited Ni nanoparticles. Ethanol can undergo dehydration and dehydrogenation processes to form C₂H₄, CH₃CHO and small amounts of H₂O and H₂ over ceria support itself as shown in the temperature programmed desorption (TPD) results. Ni is reactive toward ethanol and reaction of ethanol on Ni particles on ceria gives out CO and H₂ between 300 and 450 K. Ethanol reaction at the Ni-ceria interface produces CO and H₂ at 580 K (FIG. 1E). Unique redox properties of ceria can assist the removal of C deposits as CO gas from Ni as indicated with a desorption peak at 700 K. Partial substitution of Ce with Ti in the CeO₂(111) support provide unique sites for the promotion of Ni reactivity for the ethanol reaction (FIG. 1F). Ni is subject to coke formation during reforming processes. It is very promising, however, that removal of carbon deposits from Ni using a Ti-ceria is supported in the X-ray photoelectron spectroscopy (XPS) study of ethanol adsorption (FIGS. 1G and 1H). As a comparison, without Ti dopant in ceria, atomic-like C species persists on Ni even after heating to 700 K.

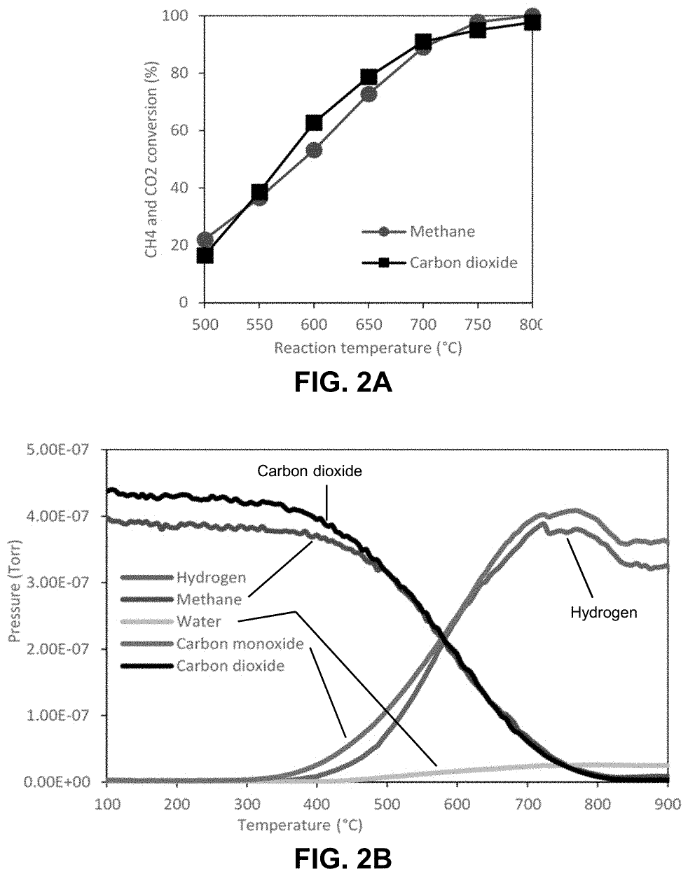

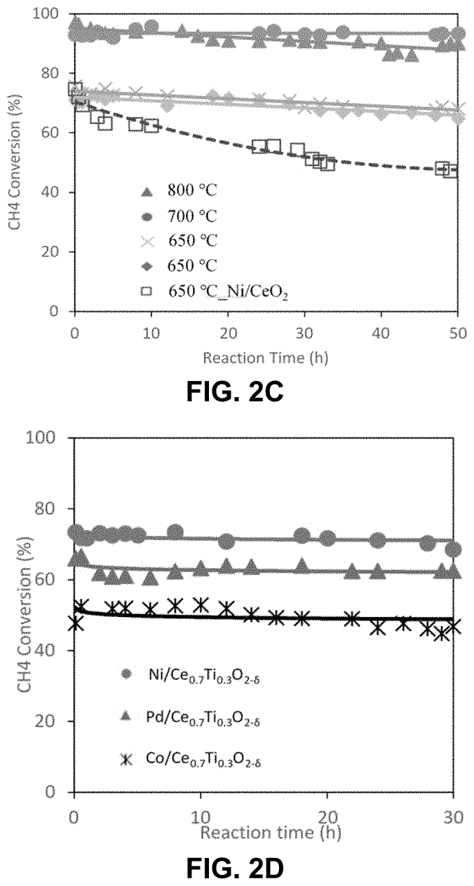

Knowledge from model catalysts of Ni/Ti-doped CeOₓ(111) studied under ultrahigh vacuum condition (pressure less than 1×10⁻¹⁰ Torr) may provide insights into real-world catalysts under reactor conditions (1 mtorr-100 Torr). We prepared practical Ni particles dispersed on Ce₁₋ₓTiₓO_{2-δ} (x: 0.1, 0.2, 0.3, and 0.5) using sol-gel methods for the DRM reaction. The amount of Ti was be varied to better tune the structure and redox properties of ceria. Loadings of nickel from 0.5-10 wt. %) on ceria supports were also be varied for the comparison of the DRM activity. It is successfully demonstrated that 2 wt. % Ni supported over Ce_{0.7}Ti_{0.3}O_{2-δ} is an active and stable DRM catalyst using laboratory-based reactors and GC/MS instruments. The catalyst delivers an outstanding CH₄ conversion of 73% at 650° C. and close to 100% CH₄ conversion at 800° C. with primarily CO and H₂ products (FIGS. 2A and 2B). The issue of coke formation and the deactivation and long-term stability behavior may be studied over 2 wt. % Ni/Ce_{0.7}Ti_{0.3}O_{2-δ}. The results support an understanding that the present catalysts maintain their activity during the time on stream for 50 hours at three temperatures of interest (FIG. 2C). The Ce_{0.7}Ti_{0.3}O_{2-δ} support can greatly promote the stability of the Ni catalyst compared to other oxide supports (e.g. CeO₂, FIG. 2C). Other metal catalysts including Pd and Co are also promising. For example, 2 wt. % Ni/Ce_{0.7}Ti_{0.3}O_{2-δ} shows the best catalytic reactivity (FIG. 2D). The Ce_{0.7}Ti_{0.3}O_{2-δ} support also minimizes the activity loss for all three metals (Ni, Pd, and Co).

In this example, metal dopants for the catalyst are selected, in addition to Ti, including Zr, Mn, and La:^{49,54,56,74,75} which provide a measure to tune redox properties and oxygen storage capacity of ceria supports and elucidate the promotional effect of the chemistry for Ni in the DRM reaction. This approach allows for a better understanding of elemental steps of the reaction including 1) methane activation, 2) CO₂ activation, and 3) reaction to form syngas as well as the issue of coking formation.

The structure at the catalytic interface is central to the chemical processes. The prepared Ni/Ce—M—O catalysts may be characterized using appropriate physical-chemical techniques. Nitrogen physisorption may be used to measure surface area, CO physisorption followed by TPD to identify variations among surface sites and temperature programmed reduction (TPR) in hydrogen to evaluate the reducibility of both the metal clusters and the support. XPS may be used to examine the surface elements present and their chemical states. SEM-EDS and XRD may be used to measure the metal cluster size and crystal structure. To understanding of the stability of the materials under high temperatures, reducing and reaction conditions, all the prepared catalysts are annealed in vacuum and H₂ environment to various temperatures. The subsequent changes in their structural and electronic properties may be investigated.

To understand the chemistry over Ni/doped ceria catalysts, the DRM reaction may be first studied on pure ceria and Ti-doped ceria supports. Various spectroscopic methods may be used to elucidate the proposed reaction mechanism. The reaction products and their yields may be monitored with a mass spectrometer. Each of the catalysts may be tested kinetically in a flow reactor to measure specific reaction rates (per metal atom, per exposed metal atom, per surface area, and/or per mass). Reaction temperatures may also be varied to determine relevant kinetic parameters of activation energy and ignition temperature for each catalyst. Infrared spectroscopy may be used to probe the surface intermediates formed during the reaction since CO, CH₃ and carbonate have signature IR bands. XPS may be used to check the carbon deposits if formed on Ni upon methane adsorption by monitoring the C1 s region. One possibility is that metal-doped ceria may act as the active phase to remove C deposit from Ni by oxidation of surface carbon with lattice O in ceria as CO. Ceria may be regenerated by taking O from CO₂ activation. Redox properties of ceria may be probed by monitoring Ce 3d, O ls and C ls XPS regions during the reaction. Using the above integrated techniques will provide a better understanding of the DRM reaction mechanism over Ni/doped ceria materials in unprecedented detail and allow the catalyst with specific composition/structure for the optimum performance to be identified.

Catalyst Synthesis: The synthesis of catalysts may involve two steps: mixed-oxide support synthesis and nickel deposition synthesis. The mixed-oxides may be produced by sol-gel (or similar techniques). These support materials are then calcined to remove the chemical precursors used to produce the support material. Next, the nickel is deposited using a wet impregnation (or other similar technique). The samples are then calcined and reduced to produce the Ni metal particles on the support.

Catalyst Characterization: Catalyst characterization may occur in two phases. Characterization of the fresh, as-made catalysts. This may include such techniques as transmission electron microscopy (TEM), XPS, and XRD. This will provide information on the initial state of the catalytic materials. Characterization may also occur on the used catalysts, again including such techniques as above. This will provide information on the “after” state of the catalysts including information on crystal structure change, particle sintering, and carbon formation.

Reactivity Studies: Reactivity studies are useful to investigate activity and selectivity of the catalyst under short-term conditions. This will allow correlation of initial catalyst properties with activity. In addition, long-term (e.g. 50 to 500 hours) stability testing is beneficial.

Results and Impacts Ce₁₋ₓTiₓO_{2-δ} catalysts exhibit dramatically improved stability (minimize deactivation) of Ni supported catalysts for dry reforming of methane. This work clearly demonstrates the ability of the Ti substitution into the ceria lattice to improve stability. Three additional ceria dopants are also options to affect catalyst reactivity/selectivity: Zr, Mn, and La. These three dopants offer the ability to modify the structural and electronic properties of the ceria in different ways that Ti can. The variation in size (Ti=1.32 ∈, Zr=1.45, Mn=1.17, and La=1.69) and electronegativity (Ti=1.54, Zr=1.33, Mn=1.55, and La=1.10) offer the ability to modify both the structural and electronic properties of the ceria in a systematic manner.

Additionally, fine tuning the amount of dopant added and the amount of Ni required as well as temperature and partial pressure effects may be used to enhance the overall reactivity and selectivity. The present approach may also be applicable for re-activating or regenerating the catalysts. Additional forms of ceria mixed-oxides may provide improved stability for dry reforming of methane catalysts.

Earth abundant metals (e.g. Ni) are useful for catalysts for dry reforming of methane to synthesis gas. These catalysts are susceptible to deactivation due to solid carbon buildup on the catalysts surface that leads to blocking of active sites. Examining catalyst reactivity and stability as a function of the support material (ceria with other metals incorporated to form mixed-metal oxides) provides a powerful tool for understanding DRM processes and identifying candidate catalyst materials. To correlate reactivity with catalyst material, advanced characterization techniques such as TEM and SEM to examine catalyst structure (of both the Ni and mixed-metal oxide) both before and after the reaction are useful to provide information on particle size, shape, and morphology. Post-reaction examination also provides information on the quantity and state of any deposited carbon. In particular, to monitor catalyst deactivation the XPS instrument with reaction chamber is a valuable technique.

To properly investigate these dry reforming catalysts, short-term and long-term studies are useful. Short-term studies provide information on catalyst reactivity and selectivity, while long-term studies provide information on catalyst deactivation/stability. Finally, many methane streams have small amounts of sulfur contamination in them. It is desirable to develop sulfur tolerant catalysts instead of inserting processes that would remove the sulfur. Thus, reactivity testing with feedstocks having sulfur contaminants may be useful for both short-term activity/selectivity studies and long-term deactivation/stability testing.

### REFERENCES

1. Pakhare, D., Spivey, J., A Review of Dry (CO₂) Reforming of Methane over Noble Metal Catalysts. Chemical Society Reviews, 2014, 43, (22), 7813-7837.

2. Ross, J. R. H., Natural Gas Reforming and CO₂ Mitigation. Catalysis Today, 2005, 100, (1-2), 151-158.

3. Aresta, M., Dibenedetto, A., Utilisation of CO₂ as a Chemical Feedstock: Opportunities and Challenges. Dalton Transactions, 2007, (28), 2975-2992.

4. Centi, G., laquaniello, G., Perathoner, S., Can We Afford to Waste Carbon Dioxide? Carbon Dioxide as a Valuable Source of Carbon for the Production of Light Olefins. ChemSusChem, 2011, 4, (9), 1265-1273.

5. Centi, G., Quadrelli, E. A., Perathoner, S., Catalysis for CO₂ Conversion: a Key Technology for Rapid Introduction of Renewable Energy in the Value Chain of Chemical Industries. Energy & Environmental Science, 2013, 6, (6), 1711-1731.

6. Dorner, R. W., Hardy, D. R., Williams, F. W., Willauer, H. D., Heterogeneous Catalytic CO₂ Conversion to Value-Added Hydrocarbons. Energy & Environmental, Science 2010, 3, (7), 884-890.

7. Cargnello, M., Jaen, J. J. D., Garrido, J. C. H., Bakhmutsky, K., Montini, T., Gamez, J. J. C., Gorte, R. J., Fornasiero, P., Exceptional Activity for Methane Combustion over Modular Pd@CeO₂ Subunits on Functionalized Al₂O₃. Science, 2012, 337, (6095), 713-717.

8. Kehres, J., Jakobsen, J. G., Andreasen, J. W., Wagner, J. B., Liu, H. H., Molenbroek, A., Sehested, J., Chorkendorff, I., Vegge, T., Dynamical Properties of a Ru/MgAl₂O₄ Catalyst during Reduction and Dry Methane Reforming. The Journal of Physical Chemistry C, 2012, 116, (40), 21407-21415.

9. Liu, Z. Y., Grinter, D. C., Lustemberg, P. G., Nguyen-Phan, T. D., Zhou, Y.

H., Luo, S., Waluyo, I., Crumlin, E. J., Stacchiola, D. J., Zhou, J., Carrasco, J., Busnengo, H. F., Ganduglia-Pirovano, M. V., Senanayake, S. D., Rodriguez, J. A., Dry Reforming of Methane on a Highly-Active Ni—CeO₂ Catalyst: Effects of Metal-Support Interactions on C—H Bond Breaking. Angewandte Chemie International Edition, 2016, 55, (26), 7455-7459.

10. Al-Doghachi, F. A. J., Rashid, U., Zainal, Z., Saiman, M. I., Yap, Y. H. T., Influence of Ce₂O₃ and CeO₂ Promoters on Pd/MgO Catalysts in the Dry-Reforming of Methane. Rsc Advances, 2015, 5, (99), 81739-81752.

11. Zhang, G. J., Liu, J. W., Xu, Y., Sun, Y. H., A Review of CH₄—CO₂ Reforming to Synthesis Gas over Ni-Based Catalysts in Recent Years (2010-2017). International Journal of Hydrogen Energy, 2018, 43, (32), 15030-15054.

12. Kawi, S., Kathiraser, Y., CO₂ as an Oxidant for High-Temperature Reactions. Frontiers in Energy Research, 2015, 3, 13-17.

13. Li, S. R., Gong, J. L., Strategies for Improving the Performance and Stability of Ni-Based Catalysts for Reforming Reactions. Chemical Society Reviews, 2014, 43, (21), 7245-7256.

14. Wei, J., Iglesia, E., Mechanism and Site Requirements for Activation and Chemical Conversion of Methane on Supported Pt Clusters and Turnover Rate Comparisons among Noble Metals. The Journal of Physical Chemistry B, 2004, 108, (13), 4094-4103.

15. Wei, J., Iglesia, E., Isotopic and Kinetic Assessment of the Mechanism of Reactions of CH₄ with CO₂ or H₂O to Form Synthesis Gas and Carbon on Nickel Catalysts. Journal of Catalysis, 2004, 224, (2), 370-383.

16. Yao, Y. X., Goodman, W., In situ IR Spectroscopic Studies of Ni Surface Segregation Induced by CO Adsorption on Cu-Ni/SiO₂ Bimetallic Catalysts. Physical Chemistry Chemical Physics, 2014, 16, (8), 3823-3829.

17. De, S., Zhang, J. G., Luque, R., Yan, N., Ni-based Bimetallic Heterogeneous Catalysts for Energy and Environmental Applications. Energy & Environmental Science, 2016, 9, (11), 3314-3347.

18. Ni, M.; Leung, D. Y. C.; Leung, M. K. H., A Review on Reforming Bio-ethanol for Hydrogen Production. International Journal of Hydrogen Energy 2007, 32, (15), 3238-3247.

19. Xu, J. Z.; Zhang, X. P.; Zenobi, R.; Yoshinobu, J.; Xu, Z.; Yates, J. T., Ethanol Decomposition on Ni(111)—Observation of Ethoxy Formation by IRAS and Other Methods. Surface Science, 1991, 256, (3), 288-300.

20. Zhou, J.; Baddorf, A. P.; Mullins, D. R.; Overbury, S. H., Growt.h and Characterization of Rh and Pd Nanoparticles on Oxidized and Reduced CeOₓ(111) Thin

Films by Scanning Tunneling Microscopy. The Journal of Physical Chemistry C, 2008, 112, (25), 9336-9345.

21. Zhou, Y.; Zhou, J., Growth and Sintering of Au—Pt Nanoparticles on Oxidized and Reduced CeOₓ(111) Thin Films by Scanning Tunneling Microscopy. Journal of Physical Chemistry Letter, 2010, 1, (3), 609-615.

22. Zhou, Y. H.; Perket, J. M.; Crooks, A. B.; Zhou, J., Effect of Ceria Support on the Structure of Ni Nanoparticles. Journal of Physical Chemistry Letters, 2010, 1, (9), 1447-1453.

23. Trovarelli, A., Catalysis by Ceria and Related Materials. Imperial College Press: London, 2002, 2, 510-512.

24. Trovarelli, A.; de Leitenburg, C.; Boaro, M.; Dolcetti, G., The Utilization of Ceria in Industrial Catalysis. Catalysis Today, 1999, 50, (2), 353-367.

25. Bunluesin, T.; Gorte, R. J.; Graham, G. W., Studies of the Water-Gas-Shift Reaction on Ceria-supported Pt, Pd, and Rh: Implications for Oxygen-storage Properties. Applied Catalysis B: Environmental, 1998, 15, (1-2), 107-114.

26. Ayastuy, J. L.; Gil-Rodriguez, A.; Gonzalez-Marcos, M. P.; Gutierrez-Ortiz, M. A., Effect of Process Variables on Pt/CeO₂ Catalyst Behaviour for the PROX Reaction. International Journal of Hydrogen Energy, 2006, 31, (15), 2231-2242.

27. Fu, Q.; Saltsburg, H.; Flytzani-Stephanopoulos, M., Active Nonmetallic Au and Pt Species on Ceria-based Water-Gas Shift Catalysts. Science, 2003, 301, (5635), 935-938.

28. Liu, P.; Rodriguez, J. A., Water-gas-shift Reaction on Metal Nanoparticles and Surfaces. Journal of Chemical Physics, 2007, 126, (16), 164705.

29. Rodriguez, J. A.; Wang, X.; Liu, P.; Wen, W.; Hanson, J. C.; Hrbek, J.; Perez, M.; Evans, J., Gold Nanoparticles on Ceria: Importance of O Vacancies in the Activation of Gold. Topics in Catalysis, 2007, 44, (1-2), 73-81.

30. Wang, X.; Rodriguez, J. A.; Hanson, J. C.; Perez, M.; Evans, J., In situ Time-Resolved Characterization of Au—CeO₂ and AuOₓ—CeO₂ Catalysts during the Water-Gas Shift Reaction: Presence of Au and O Vacancies in the Active Phase. Journal of Chemical Physics, 2005, 123, (22), 221101.

31. Stubenrauch, J.; Vohs, J. M., Support Effects in the Dissociation of CO on Rh/CeO₂(111). Catalysis Letters, 1997, 47, (1), 21-25.

32. Weststrate, C. J.; Resta, A.; Westerstrom, R.; Lundgren, E.; Mikkelsen, A.; Andersen, J. N., CO Adsorption on a Au/CeO₂(111) Model Catalyst. The Journal of Physical Chemistry C, 2008, 112, (17), 6900-6906.

33. Weststrate, C. J.; Westerstrom, R.; Lundgren, E.; Mikkelsen, A.; Andersen, J. N., Influence of Oxygen Vacancies on the Properties of Ceria-Supported Gold. The Journal of Physical Chemistry C, 2009, 113, (2), 724-728.

34. Kundakovic, L.; Mullins, D. R.; Overbury, S. H., Adsorption and reaction of H₂O and CO on oxidized and reduced Rh/CeOₓ(111) surfaces. Surface Science, 2000, 457, (1-2), 51-62.

35. Mullins, D. R.; Zhang, K. Z., Metal-support Interactions between Pt and Thin Film Cerium Oxide. Surface Science, 2002, 513, (1), 163-173.

36. Andreeva, D.; Ivanov, I.; Ilieva, L.; Sobczak, J. W.; Avdeev, G.; Petrov, K., Gold based catalysts on ceria and ceria-alumina for WGS reaction (WGS Gold catalysts). Topics in Catalysis, 2007, 44, (1-2), 173-182.

37. Lu, J. L.; Gao, H. J.; Shaikhutdinov, S.; Freund, H. J., Gold Supported on Well-Ordered Ceria Films: Nucleation, Growth and Morphology in CO Oxidation Reaction. Catalysis Letters, 2007, 114, (1-2), 8-16.

38. Baron, M.; Bondarchuk, O.; Stacchiola, D.; Shaikhutdinov, S.; Freund, H. J., Interaction of Gold with Cerium Oxide Supports: CeO₂(111) Thin Films vs CeOx Nanoparticles. The Journal of Physical Chemistry C, 2009, 113, (15), 6042-6049.

39. Henderson, M. A.; Perkins, C. L.; Engelhard, M. H.; Thevuthasan, S.; Peden, C. H. F., Redox Properties of Water on the Oxidized and Reduced Surfaces of CeO₂(111). Surface Science, 2003, 526, (1-2), 1-18.

40. Park, J. B.; Graciani, J.; Evans, J.; Stacchiola, D.; Senanayake, S. D.; Barrio, L.; Liu, P.; Sanz, J. F.; Hrbek, J.; Rodriguez, J. A., Gold, Copper, and Platinum Nanoparticles Dispersed on CeOₓ/TiO₂(110) Surfaces: High Water-Gas Shift Activity and the Nature of the Mixed-Metal Oxide at the Nanometer Level. Journal of the American Chemical Society, 2010, 132, (1), 356-363.

41. Rodriguez, J. A.; Graciani, J.; Evans, J.; Park, J. B.; Yang, F.; Stacchiola, D.; Senanayake, S. D.; Ma, S. G.; Perez, M.; Liu, P.; Sanz, J. F.; Hrbek, J., Water-Gas Shift Reaction on a Highly Active Inverse CeOx/Cu(111) Catalyst: Unique Role of Ceria Nanoparticles. Angewandte Chemie International Edition, 2009, 48, (43), 8047-8050.

42. Wang, X.; Gorte, R. J.; Wagner, J. P., Deactivation Mechanisms for Pd/Ceria during the Water-Gas-Shift Reaction. Journal of Catalysis, 2002, 212, (2), 225-230.

43. Karpenko, A.; Leppelt, R.; Cai, J.; Plzak, V.; Chuvilin, A.; Kaiser, U.; Behm, R. J., Deactivation of a Au/CeO₂ Catalyst during the Low-Temperature Water-Gas Shift Reaction and Its Reactivation: A Combined TEM, XRD, XPS, DRIFTS, and Activity Study. Journal of Catalysis, 2007, 250, (1), 139-150.

44. Rao, G. R.; Kaspar, J.; Meriani, S.; Dimonte, R.; Graziani, M., NO Decomposition over Partially Reduced Metallized CeO₂—ZrO₂ Solid-Solutions. Catalysis Letters, 1994, 24, (1-2), 107-112.

45. Di Monte, R.; Kaspar, J., Nanostructured CeO2-ZrO2 Mixed Oxides. Journal of Materials Research, 2005, 15, (6), 633-648.

46. Rynkowski, J.; Farbotko, J.; Touroude, R.; Hilaire, L., Redox Behaviour of Ceria-Titania Mixed Oxides. Applied Catalysis A: General, 2000, 203, (2), 335-348.

47. Rodriguez, J. A.; Wang, X.; Liu, G.; Hansona, J. C.; Hrbek, J.; Peden, C. H. F.; Iglesias-Juez, A.; Fernandez-Garcia, M., Physical and Chemical Properties of Ce₁₋ₓZrₓO₂ Nanoparticles and Ce₁₋ₓZrₓO₂(111) Surfaces: Synchrotron-based Studies. Journal of Molecular Catalysis A: Chemical, 2005, 228, (1-2), 11-19.

48. Rodriguez, J. A.; Hanson, J. C.; Kim, J. Y.; Liu, G.; Iglesias-Juez, A.; Fernandez-Garcia, M., Properties of CeO₂ and Ce₁₋ₓZrₓO₂ Nanoparticles: X-ray Absorption Near-edge Spectroscopy, Density Functional, and Time-resolved X-ray Diffraction Studies. The Journal of Physical Chemistry B, 2003, 107, (15), 3535-3543.

49. Reddy, B. M.; Khan, A., Nanosized CeO₂-SiO₂, CeO₂—TiO₂, and CeO₂—ZrO₂ Mixed Oxides: Influence of Supporting Oxide on Thermal Stability and Oxygen Storage Properties of Ceria. Catalysis Surveys from Asia, 2005, 9, (3), 155-171.

50. Overbury, S. H.; Huntley, D. R.; Mullins, D. R.; Glavee, G. N., XANES Studies of the Reduction Behavior of (Ce_{1-y}Zr_{y})O₂ and Rh/(Ce_{1-y}Zr_{y})O₂. Catalysis Letters 1998, 51, (3-4), 133-138.

51. Liu, G.; Rodriguez, J. A.; Hrbek, J.; Dvorak, J.; Peden, C. H. F., Electronic and Chemical Properties of Ce_{0.8}Zr_{0.2}O₂(111) Surfaces: Photoemission, XANES, Density-Functional, and NO₂ Adsorption Studies. The Journal of Physical Chemistry B, 2001, 105, (32), 7762-7770.

52. Balducci, G.; Fornasiero, P.; Dimonte, R.; Kaspar, J.; Meriani, S.; Graziani, M., An Unusual Promotion of the Redox Behavior of CeO₂—ZrO₂ Solid-Solutions Upon Sintering at High-Temperatures. Catalysis Letters, 1995, 33, (1-2), 193-200.

53. Fornasiero, P.; Dimonte, R.; Rao, G. R.; Kaspar, J.; Meriani, S.; Trovarelli, A.; Graziani, M., Rh-loaded CeO2-ZrO2 Solid-Solutions as Highly Efficient Oxygen Exchangers—Dependence of the Reduction Behavior and the Oxygen Storage Capacity on the Structural Properties. Journal of Catalysis, 1995, 151, (1), 168-177.

54. Reddy, B. M.; Khan, A.; Yamada, Y.; Kobayashi, T.; Loridant, S.; Volta, J. C., Structural Characterization of CeO₂—MO₂ (M=Si⁴⁺, Ti⁴⁺, and Zr⁴⁺) Mixed Oxides by Raman Spectroscopy, X-ray Photoelectron Spectroscopy, and Other Techniques. The Journal of Physical Chemistry B, 2003, 107, (41), 11475-11484.

55. Yang, Z.; Woo, T. K.; Hermansson, K., Effects of Zr Doping on Stoichiometric and Reduced Ceria: A First-principles Study. Journal of Chemical Physics, 2006, 124, (22), 224704.

56. Dutta, G.; Waghmare, U. V.; Baidya, T.; Hegde, M. S.; Priolkar, K. R.; Sarode, P. R., Origin of Enhanced Reducibility/Oxygen Storage Capacity of Ce₁₋ₓTiₓO₂ Compared to CeO₂ or TiO₂. Chemistry of Materials, 2006, 18, (14), 3249-3256.

57. Baidya, T.; Priolkar, K. R.; Sarode, P. R.; Hegde, M. S.; Asakura, K.; Tateno, G.; Koike, Y., Local Structure of Pt and Pd Ions in Ce₁₋ₓTiₓO₂: X-ray Diffraction, X-ray Photoelectron Spectroscopy, and Extended X-ray Absorption Fine Structure. Journal of Chemical Physics, 2008, 128, (12), 124711.

58. Yang, Z. X.; Wei, Y. W.; Fu, Z. M.; Lu, Z. S.; Hermansson, K., Facilitated Vacancy Formation at Zr-doped Ceria(111) Surfaces. Surface Science, 2008, 602, (6), 1199-1206.

59. Nagai, Y.; Yamamoto, T.; Tanaka, T.; Yoshida, S.; Nonaka, T.; Okamoto, T.; Suda, A.; Sugiura, M., X-ray Absorption Fine Structure Analysis of Local Structure of CeO₂—ZrO₂ Mixed Oxides with the Same Composition Ratio (Ce/Zr=1). Catalysis Today, 2002, 74, (3-4), 225-234.

60. Guo, Y.; Lu, G. Z.; Zhang, Z. G.; Zhang, S. H.; Qi, Y.; Liu, Y., Preparation of CeₓZr₁₋ₓO₂ (x=0.75, 0.62) Solid Solution and Its Application in Pd-only Three-Way Catalysts. Catalysis Today, 2007, 126, (3-4), 296-302.

61. Lu, Z.; Yang, Z., Interfacial Properties of Ce_{0.75}Zr_{0.25}O₂ Supported Noble Metals (Pd, Pt) from First Principles. European Physical Journal B, 2008, 63, (4), 455-460.

62. Zhu, H. Q.; Qin, Z. F.; Shan, W. J.; Shen, W. J.; Wang, J. G., CO Oxidation at Low Temperature over Pd Supported on CeO2-TiO2 Composite Oxide. Catalysis Today, 2007, 126, (3-4), 382-386.

63. Shapovalov, V.; Metiu, H., Catalysis by Doped Oxides: CO Oxidation by AuₓCe₁₋ₓO₂. Journal of Catalysis, 2007, 245, (1), 205-214.

64. Ye, J. L.; Wang, Y. Q.; Liu, Y.; Wang, H., Steam Reforming of Ethanol over Ni/CeₓTi₁₋ₓO₂ Catalysts. International Journal of Hydrogen Energy, 2008, 33, (22), 6602-6611.

65. Jain, A.; Zhao, X.; Kjergaard, S.; Stagg-Williams, S. M., Effect of Aging Time and Calcination on the Preferential Oxidation of CO over Au Supported on Doped Ceria. Catalysis Letters, 2005, 104, (3-4), 191-197.

66. Manzoli, M.; Avgouropoulos, G.; Tabakova, T.; Papavasiliou, J.; loannides, T.; Boccuzzi, F., Preferential CO Oxidation in H₂-rich Gas Mixtures over Au/doped Ceria Catalysts. Catalysis Today, 2008, 138, (3-4), 239-243.

67. Biswas, P.; Kunzru, D., Steam Reforming of Ethanol on Ni—CeO₂—ZrO₂ Catalysts: Effect of Doping with Copper, Cobalt and Calcium. Catalysis Letters, 2007, 118, (1-2), 36-49.

68. Srinivas, D.; Satyanarayana, C. V. V.; Potdar, H. S.; Ratnasamy, P., Structural Studies on NiO—CeO₂—ZrO₂ Catalysts for Steam Reforming of Ethanol. Applied Catalysis A: General, 2003, 246, (2), 323-334.

69. Wang, R.; Crozier, P. A.; Sharma, R.; Adams, J. B., Measuring the Redox Activity of Individual Catalytic Nanoparticles in Cerium-based Oxides. Nano Letter, 2008, 8, (3), 962-967.

70. Avgouropoulos, G.; Manzoli, M.; Boccuzzi, F.; Tabakova, T.; Papavasiliou, J.; loannides, T.; Idakiev, V., Catalytic Performance and Characterization of Au/doped-ceria Catalysts for the Preferential CO Oxidation Reaction. Journal of Catalysis, 2008, 256, (2), 237-247.

71. Zhou, Y. H., Zhou, J., Interactions of Ni Nanoparticles with Reducible CeO₂ (111) Thin Films. The Journal of Physical Chemistry C, 2012, 116, (17), 9544-9549.

72. Zhou, Y. H., Zhou, J., Ti/CeOₓ (111) Interfaces Studied by XPS and STM. Surface Science, 2012, 606, (7-8), 749-753.

73. Zhou, Y. H., Zhou, J., Growth and Surface Structure of Ti-Doped CeOₓ (111) Thin Films. Journal of Physical Chemistry Letters, 2010, 1, (11), 1714-1720.

74. Vlaic, G.; Di Monte, R.; Fornasiero, P.; Fonda, E.; Kaspar, J.; Graziani, M., The CeO₂—ZrO₂ System: Redox Properties and Structural Relationships. In Catalysis and Automotive Pollution Control IV 1998, 116, 185-195.

75. Youn, M. H.; Seo, J. G.; Park, S.; Park, D. R.; Jung, J. C.; Kim, P.; Song, I. K., Hydrogen Production by Auto-thermal Reforming of Ethanol over Ni—Ti—Zr Metal Oxide Catalysts. Renewable Energy, 2009, 34, (3), 731-735.

### EXAMPLE 2

### Activity of Ce₁₋ₓTiₓO_{2-δ} Supported Nickel Catalysts for Dry Reforming of Methane

Abstract

Active Ce₁₋ₓTiₓO_{2-δ} (x=0.1-0.5) supported nickel were synthesized by sol-gel and impregnation methods. X-ray diffraction data show the formation of Ce₁₋ₓTiₓO_{2-δ} mixed oxides for lower Ti compositions. NiO is formed over Ce₁₋ₓTiₓO_{2-δ} and its particle size increases with the nickel loading from 0.5 to 10 wt. %. The dry reforming of methane activity over Ni depends on the composition of the support, the Ni loading, and the reaction temperature. Optimum activity was observed over 2.4 wt. % Ni supported on Ce_{0.7}Ti_{0.3}O_{2-δ}. It delivers CH₄ and CO₂ conversions of 54% and 61% with H₂ and CO yields of 51% and 56% at 650° C. 92% and 94% of CH₄ and CO₂ conversions with the H₂/CO ratio close to unity can be obtained at 800° C. The enhanced reactivity and stability of the catalyst is attributed to the effect of Ti doping in ceria as well as the strong interaction between Ni and Ce_{0.7}Ti_{0.3}O_{2-δ}.

1. Introduction

Dry reforming of methane (DRM, CH₄+CO₂→2H₂+2CO, ΔH_{298K}=+247 kJ*mol⁻¹) has attracted attention over recent decades because of (a) simultaneous utilization of two major greenhouse gases (CH₄ and CO₂) and (b) the ability to produce syngas (mixture of H₂ and CO) over heterogeneous catalysts. [1-3] Hydrogen is the product from DRM and can be used as an energy source. [4] The syngas can be converted further into synthetic petroleum as fuels. [5] Compared to other reforming processes including steam reforming of methane and partial oxidation of methane, DRM is environmentally friendly. [6-8] The proportional consumption of carbon dioxide and methane could reduce the carbon impact that leads to a “greener” consumption of methane. The reaction also favors the formation of a H₂/CO ratio close to unity that is desirable for Fischer-Tropsch process. [9] While DRM is endothermic in nature and requires high reaction temperatures, there are studies that indicated the use of DRM for industrial processes that contain both methane and CO₂ could lower the overall operation cost by 20% compared to other reforming reactions. [1, 10] However, the DRM reaction is accompanied with two major side reactions: Boudouard reaction (2CO→C+CO₂, ΔH_{298K}=171 kJ*mol⁻¹) and methane activation (CH₄→2H₂+C, ΔH_{298K}=+75 kJ*mol⁻¹), both of which can cause the deposition of coke over the catalyst and thus the catalyst deactivation. [1, 3]

Oxide supported metal catalysts have been widely studied for DRM. [11, 12] The overall activity depends on the type of the active metal, the nature of the support including the basicity/acidity and oxygen storage capacity, and the interaction between the metal and support. [1, 13-15] It is commonly viewed that oxide supports, which can disperse the active metal and allow a better interaction with CO₂, are desirable for DRM. [16, 17] Since the metal acts as active sites where CH₄ is adsorbed and dissociated, it is important that the metal has high activity for C—H bond cleavage. [1] Noble metals, including Rh, Ru, Pt have been proven to perform well for DRM and show great thermal stability and coke resistance. [18-21] However, the high cost and limited availability of these metals restrict their use for commercial catalysts. The use of a Ni-based catalyst is more desirable in DRM because it is highly active for methane dissociation and more economical and easily available. [17, 22] However, Ni may be prone to deactivation due to carbon deposits. [23] Nickel nanoparticles also sinter at high reaction temperatures, which may result in the loss of catalyst activity during the reaction. [2] To help disperse Ni as small nanoparticles and promote the DRM catalytic activity and stability towards carbon deposition, various oxides including Al₂O₃ [24], TiO₂ [25], SiO₂ [26], MgO [27], ZrO₂ [28], La₂O_{3 [29],} CeO₂[22, 30], and Ce₁₋ₓZrₓO₂ [31] have been examined as the supports for Ni.

Ceria has been considered as a promising support for DRM due to its unique redox properties, high oxygen storage capacity, and strong metal-support interactions (SMSI). [32-34] Over ceria-supported Ni, ceria contributes to the adsorption and activation of CO₂. Methane activation occurs over Ni, which can be promoted by the ceria support. As shown in the study by Rodriguez's group, Ni—CeO₂ catalysts show DRM activity at a low temperature (427° C.). Density-functional results of their experiment show that the effective barrier for methane activation is lowered from 0.88 eV on Ni (111) to 0.15 eV when Ni is supported over CeO₂₋ₓ (111). [22] In the DRM reaction, the presence of the ceria support can also suppress carbon deposition over Ni to a degree, which increases the catalytic performance and stability of Ni. [35] This is due to unique redox properties of CeO₂ as demonstrated in the facile transition between Ce⁴⁺ and Ce³⁺ and formation of oxygen vacancies in the lattice; therefore, it can act as an oxygen buffer in a redox reaction. [36, 37] Reduced ceria with oxygen vacancies can promote the oxidation of surface carbon derived from methane, which has been shown to be a crucial ability to resist coke deposits. [21] Moreover, SMSI can assist in anchoring and stabilizing Ni and thus the extent of the of Ni particle sintering at high temperatures can be reduced. [38, 39] Good oxygen storage capacity of ceria and strong SMSI can also promote promising dry reforming activity and stability of Ni when using other hydrocarbons. [40-42]

Despite continuing efforts and research interest in DRM catalysts, there is still a strong need to develop stable, efficient, and economical catalysts that can effectively work at desirable reaction temperatures with high conversion of reactants, high yield of products, and coke resistance to avoid catalyst deactivation. [1, 2, 23] Ni supported on CeO₂ has been shown to be an effective catalyst for DRM. [22, 43] Metal-doped ceria could provide a potentially better catalytic support for practical applications compared to pure ceria. [44, 45] One main issue regarding the use of pure ceria as real-world catalytic supports is its poor thermal stability at high temperatures. [46] It can undergo sintering which causes the loss of its crucial oxygen storage capacity and redox properties. To overcome the issue, doping ceria with additional metal elements can enhance its thermal stability. [47] The interaction of metal dopant with ceria can also lower the activation energy needed for the release of oxygen, which results in the improvement of its redox properties and oxygen storage capacity and consequently the enhancement of its catalytic activity. [48-51] Ti was found to be a good dopant to ceria. [44, 52-54] Ti-doped ceria has a lower formation energy of oxygen vacancies compared to pure ceria. [55, 56] The Ce/Ti ratio can be an important parameter in tuning the properties of ceria. Petallidou and coworkers [57] prepared and tested Pt/Ce₁₋ₓTiₓO₂ catalysts for the water-gas shift reaction, and they observed enhanced reducibility and improved activity over ceria support with a Ce/Ti ratio of 4/1 compared to Ni/CeO2. [45, 58] Our group has been interested in the study of model CeO₂(111) thin films with Ti dopants and our results show that doping ceria with Ti can significantly reduce the sintering of metal particles including Ni with heating in vacuum. [55, 59, 60] In this present work, we report the preparation of Ni/Ce₁₋ₓTiₓO_{2-δ} powder samples with controlled Ce/Ti composition ratios by sol-gel methods. Here, δ indicates the loss oxygen from stoichiometric CeO₂ and x represents the Ti doping composition in ceria. The role of Ti-doped ceria supports was studied in detail in our study with respect to the reactivity, stability, and coke resistance of Ni in the DRM reaction.

2. Materials and methods

2.1 Synthesis of Ce₁₋ₓTiₓO_{2-δ} Supported Ni Catalysts

Ce₁₋ₓTiₓO_{2-δ} with controlled Ti compositions (0.0≤x≤0.5) was prepared by mixing proper amounts of cerium (III) nitrate hexahydrate and titanium (IV) isopropoxide (Sigma Aldrich) with citric acid (Fisher Scientific, USA). [57] For an example, 5.670 g of citric acid, 6.312 g of cerium (III) nitrate hexahydrate, and 62.3 mL of titanium (IV) isopropoxide stock solution (28.302 g/L) were used for the preparation of Ce_{0.7}Ti_{0.3}O_{2-δ}. The mixture was heated at 60° C. under stirring until the formation of a gel. The gel material was dried at 120° C. for 17 h and subsequently calcined at 800° C. for 2 h to remove the precursor materials. The obtained product displayed a light-yellow color. Ce₁₋ₓTiₓO_{2-δ} supported nickel catalysts were prepared by the impregnation method. Initially, 1.0 M nickel stock solution was prepared by dissolving a known quantity of nickel (II) nitrate hexahydrate (Sigma Aldrich) with deionized water. Then, 1.000 g of Ce₁₋ₓTiₓO_{2-δ} was added into the appropriate Ni stock solution under stirring. Ni samples with nominal loadings between 0.5 and 10.0 wt. % were prepared by varying the quantity of nickel stock solution. The mixture was stirred for 2 h at 70° C. followed by drying at 120° C. for 12 h. The dried powder was calcined at 800° C. for 2 h in the furnace to remove the organic impurity from the catalyst. The calcined catalyst was stored into an airtight container.

2.2 Characterization of Ni/Ce₁₋ₓTiₓO_{2-δ} Catalysts

The catalysts as synthesized as well as after DRM reactivity tests were characterized using physical and chemical techniques. X-ray diffraction (XRD) of powder samples were recorded on a Rigaku smartlab diffractometer with Cu Kα radiation (40 kV, 40 mA, 1.5419 Å) and a scanning rate of 20 ° /min. The diffraction patterns were collected at ambient conditions between 20 values of 20° and 90° with a step size of 0.02°. The crystal phases of catalysts were identified using the JCPDS database. The lattice spacing of ceria supports and Ni particle size derived from the peak positions were determined based on Bragg's diffraction law and Scherrer equation. SEM-EDS techniques were used for the analysis of surface morphology and chemical composition of the samples using a FEI Quanta 250 apparatus. The samples were prepared by crushing into small powders and dispersing onto a thin layer of a carbon tape. The actual Ni loading was examined by inductively coupled plasma optical emission spectrometry (ICP-OES, Perkin Elmer Elan 6000) with sample preparation of dissolving catalysts in aqua regia solutions. The Brunauer-Emmet-Teller (BET) surface area of the samples was performed by N₂ physisorption acquired at liquid N₂ temperature (−196° C.) using a Micromeritics ASAP 2020 apparatus. Before the analysis, all powder samples were degassed at 120° C. for 200 min under vacuum conditions. The metal dispersion and metallic surface area of fresh catalysts were examined by H₂ chemisorption using the same Micromeritics ASAP 2020 instrument. The analysis was performed using 0.100 g of catalyst. The samples were preheated in the helium flow at 110° C. for 30 min and reduced in hydrogen flow at 400° C. for 60 min. An evacuation was applied at 400° C. and 35° C. for 120 min. Then the analysis was performed at 35° C.

2.3 Catalytic Testing

Dry reforming of methane was carried out in a fixed-bed continuous flow reactor that is made up of a quartz glass with an internal diameter of 0.25 inches and a length of 24 inches. The catalytic bed of the reactor was placed at the center in the ceramic fiber heater (VC402A12A, WATLOW, USA) equipped with a ramp controller (CN7800, Omega). Mass flow controllers (FMA-700 Series, Omega) were used to control gas flow rates for all reactivity tests. Typically, 0.100 g of the powder catalyst was packed into the middle of the glass tube reactor and retained by quartz wool at both ends. The actual temperature of catalyst bed was measured by a K-type thermocouple that is close the catalyst bed. Helium gas was purged through the reactor at 50 ml/min for 15 min to maintain an inert atmosphere in the reactor prior to heating to the desired reaction temperature. Catalysts were reduced at 400° C. or 550° C. with a 20 ml/min flow rate of hydrogen for 1 hour, followed by cooling down to room temperature. A total flow of 25 ml/min with a 1:1 ratio of CH₄(99.97% purity, UHP grade, Rocky Mountain Air Solutions) and CO₂ (99.998% purity, UHP grade, PRAXAIR) was introduced for the DRM reaction. GHSV of 15 L g⁻¹h⁻¹ is determined based on the catalyst mass of 0.100 g. A flow of 30 ml/min He (99.995%, UHP grade, PRAXAIR) was also added as the carrier gas (GHSV=33 L g⁻¹h⁻¹) for DRM and the catalytic performance was measured to be the same as to the reactant gas mixture without He. Catalytic tests were performed at temperatures ranging from 300 to 800° C. The outlet gas composition of reactants and products after condensation of H₂O was analyzed after 10-30 min of reaction at selected temperatures using an online gas chromatograph (Trace ultra, Thermo scientific) equipped with thermal conductivity detector (TCD) and a HP-PLOT/Q+PT column (60 m×0.535 mm×40 μm). A flow of 2 ml/min of nitrogen (99.999% UHP grade, PRAXAIR) was used as a carrier gas throughout the GC analysis. The conversion of the reactants and yield of products were calculated using the following equations. [61, 62] The spent catalysts were collected by running inert He gas after the DRM reaction, followed by cooling down to room temperature and stored in an airtight container.

$${CH}_{4} Conversion ( \% ) = \frac{\text{moles of} {CH}_{4} \text{converted}}{\text{moles of} {CH}_{4} input} ⨯ 100 \% \qquad Eq . 1$$

$${CO}_{2} Conversion ( \% ) = \frac{\text{moles of} {CO}_{2} \text{converted}}{\text{moles of} {CO}_{2} input} ⨯ 100 \% \qquad Eq . 2$$

$${H}_{2} Yield ( \% ) = \frac{\text{moles of} {H}_{2} \text{produced}}{2 ⨯ moles of {H}_{2} input} ⨯ 100 \% \qquad Eq . 3$$

$$CO Yield ( \% ) = \frac{\text{moles of} CO \text{produced}}{( \begin{matrix}\text{moles of} {CH}_{4} input + \\ \text{moles of} {CO}_{2} input\end{matrix} )} ⨯ 100 \% \qquad Eq . 4$$

3. Results and Discussion

3.1 The effect of Reaction Temperatures and Ce/Ti Ratios

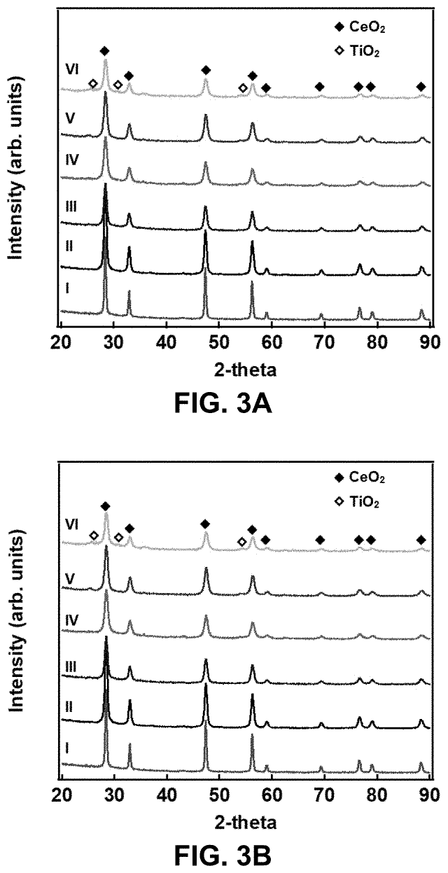

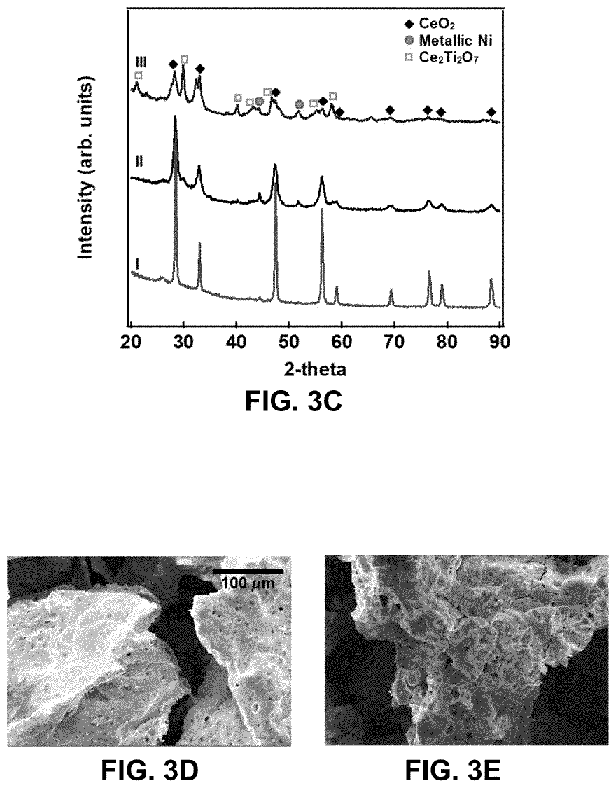

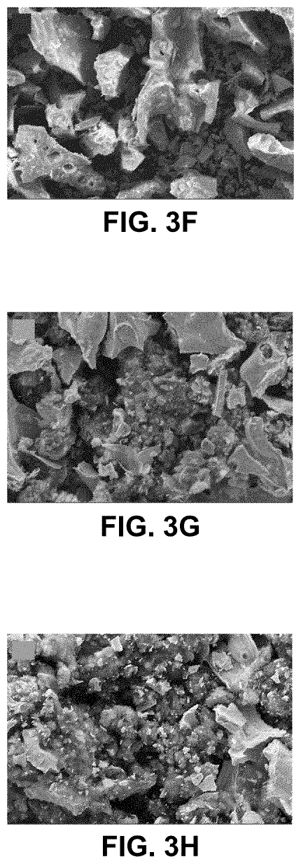

Ce/Ti ratios were varied in the synthesis of Ce₁₋ₓTiₓO_{2-δ} supports for Ni and the XRD patterns of ceria supports with different Ti concentrations are reported in FIG. 3A. Pure CeO₂ exhibits sharp XRD peaks. Different peaks of CeO₂ were observed at 28.5°, 33.1°, 47.5°, 56.3°, 59.1°, 69.4°, 76.7°, 79.1°, and 88.4° which can be attributed to (111), (200), (220), (311), (222), (400), (331), (420), and (422) planes of the face-centered cubic cell of the fluorite structure of ceria (JCPDS 43-1002). The XRD patterns of Ce₁₋ₓTiₓO_{2-δ} (x=0.1, 0.2, and 0.3) show the same diffraction peaks as those from CeO₂. However, the CeO₂ peaks broaden with increasing Ti doping in ceria. New XRD peaks at 25.3°, 30.9° and 54.3° corresponding TiO₂ (JCPDS 21-1272 and JCPDS 29-1360) were observed for Ce_{0.6}Ti_{0.4}O_{2-δ} and Ce_{0.5}Ti_{0.5}O_{2-δ}, which suggests the formation of segregated titania crystallites in these samples. Lattice constants calculated based on the XRD data demonstrate a decrease of the ceria lattice value from 5.42 to 5.39 Å with an increase of Ti composition, x, from 0.0 to 0.5. This is consistent with incorporation of Ti⁴⁺ into ceria and formation of a Ce₁₋ₓTiₓO_{2-δ} mixed oxide. The atomic radius of Ti⁴⁺ (0.75 A) is smaller than that of Ce⁴⁺ (0.97 Å) and substitution of Ce with Ti would result in a smaller crystal size of the material. [63] The decreasing trend of lattice constants is also in agreement with the previously reported study over Ce₁₋ₓTiₓO_{2-δ}. [57] Our XRD data show that uniform mixed oxides of Ce₁₋ₓTiₓO_{2-δ} can be prepared with lower Ce/Ti ratios using the sol-gel method, which is supported by the SEM-EDS results (FIGS. 3D-3H). SEM images of CeO₂ and Ce_{0.7}Ti_{0.3}O_{2-δ} catalysts are presented in FIGS. 3D and 3E. Pure CeO₂ shows the dense morphology formed by large agglomeration of particles indicated in FIG. 3D. Pores were observed on the surface of the material. The Ce_{0.7}Ti_{0.3}O_{2-δ} support displays a similar structure compared to that of CeO₂shown in FIG. 3E. The composition analysis by energy dispersive spectroscopy (not shown) shows Ce and O constituents in the CeO₂ sample. The mixed oxide (e.g. Ce_{0.7}Ti_{0.3}O_{2-δ}) shows three constituents, Ce, Ti, and O with the corresponding weight percent value of 56.8%, 8.6%, and 34.6% that are consistent to the Ce_{0.7}Ti_{0.3}O_{2-δ} sample. Furthermore, energy dispersive spectroscopy for elemental mapping data (not shown) suggest that all three elements are uniformly distributed across the sample.

FIG. 3B shows the XRD patterns of Ni supported over ceria with varied Ce/Ti ratios and a nominal Ni weight loading of 3 wt. %. No XRD peak of Ni species was observed in all the spectra at this Ni loading level. SEM images of the Ni/Ce_{0.7}Ti_{0.3}O_{2-δ} catalysts are presented as an example in FIG. 3F. The EDS spectrum of the sample displays the presence of all expected constitutes including Ce (59.6 wt. %), Ti (8.7 wt. %), Ni (2.4 wt. %), and 0 (29.3 wt. %). The weight loading of Ni was determined further to be 2.4 wt. % by ICP-OES analysis. The BET surface area values of as-synthesized supports are in the range between 10-40 m²/g. The highest surface area of the supports was obtained at a Ce/Ti ratio of 7/3. After adding 2.4 wt. % of Ni, a drop in the BET surface area value was observed among all the ceria supports.

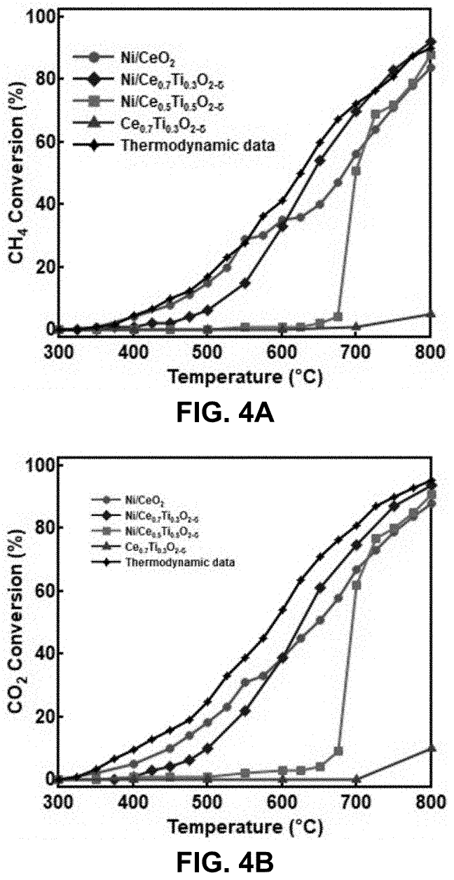

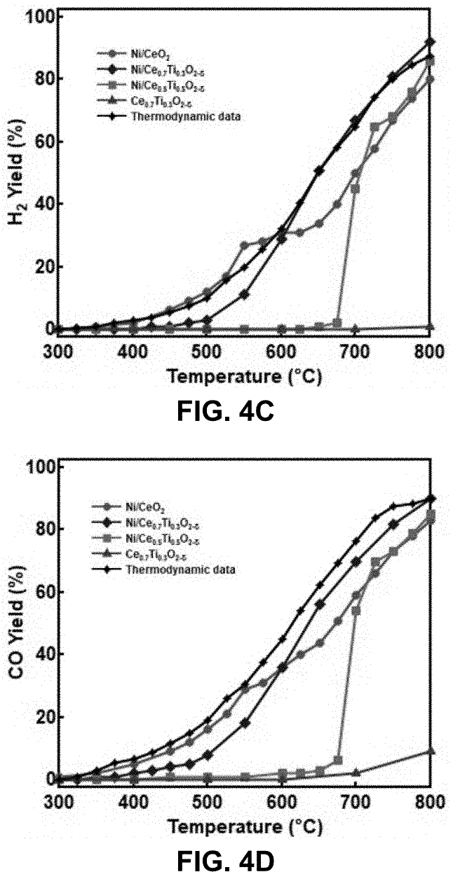

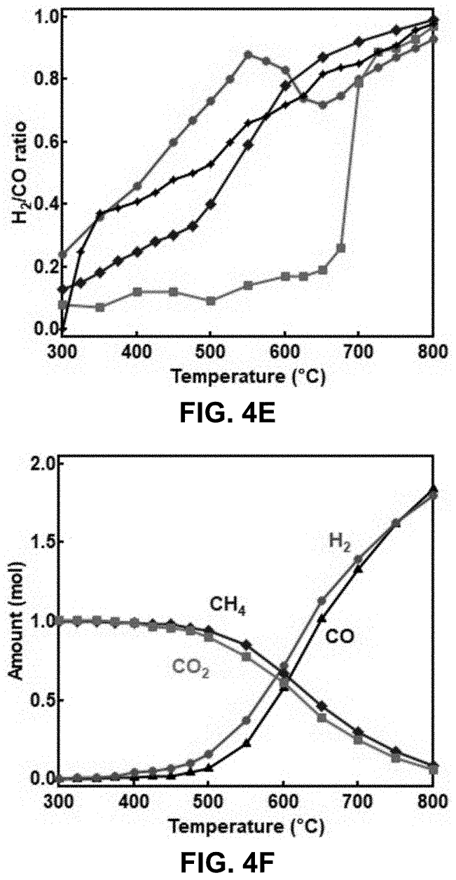

FIGS. 4A-4F show the temperature-dependent DRM activity over Ni with a 3 wt. % loading dispersed on CeO₂, Ce_{0.7}Ti_{0.3}O_{2-δ}, and Ce_{0.5}Ti_{0.5}O_{2-δ}. The choice of the supports was based on our studies of the methane activation/decomposition activity at 500° C. (data not shown). In methane decomposition, carbon and hydrogen are formed upon C—H bond breaking. The catalytic decomposition of methane is considered as a metal catalyzed reaction and a high hydrogen yield can be achieved at elevated temperatures. Our data show the methane conversion with corresponding hydrogen yield over Ni decreases with the increase of Ti doping composition from 0 to 0.5 in Ce₁₋ₓTiₓO_{2-δ} except for Ni over the Ce_{0.7}Ti_{0.3}O_{2-δ} support. Ni/Ce_{0.7}Ti_{0.3}O_{2-δ} exhibits the highest reaction activity toward methane decomposition among Ni supported over all synthesized ceria supports shown in FIG. 3A. Therefore, Ce_{0.7}Ti_{0.3}O_{2-δ} along with reference samples of pure CeO₂ and Ce_{0.5}Ti_{0.5}O_{2-δ} were chosen as the catalytic supports for Ni for the DRM reaction to elucidate the effect of Ce/Ti ratios (FIGS. 4A-4F).

0.100 g of catalyst was used in the DRM reaction and the temperature was increased from 300 to 800° C. The gaseous products (H₂ and CO) and unreacted reactants (CH₄ and CO₂) were analyzed by GC after a 10-30 min reaction time for each temperature increment of 25 or 50° C. (FIGS. 4A-4F). The reactant conversions for CH₄ and CO₂ continuously increase with the increase of the temperature, which is attributed to the endothermic nature of the DRM reaction. The conversion of relatively equal amount of CH₄ and CO₂ was observed. Over the Ni/Ce_{0.7}Ti_{0.3}O_{2-δ} catalyst with a 2.4 wt. % Ni loading as confirmed by ICP measurements, 54% and 61% of CH₄ and CO₂ conversions were observed at 650° C. H₂ and CO yields are 51% and 56%. 92% and 94% of CH₄ and CO₂ conversions were observed when further increasing the temperature to 800° C. as indicated in FIGS. 4A and 4B. The yield of products (H₂ and CO) increase with the increase in the conversion of the reactants at higher reaction temperatures. H₂ yield increases by 41 percentage points upon raising the temperature from 650 to 800° C. as shown in FIG. 4C. The results are close to the reported thermodynamic equilibrium data, suggesting that the catalyst has a high DRM activity. [1] Shinde and Madras have reported equal conversions of both reactants (CH₄ and CO₂) for the DRM reaction over the Ni/TiO₂ catalyst between 400 and 700° C., due to negligible reverse water gas shift reaction (RWGS: H₂+CO₂→H₂O+CO, ΔH_{298K}=+41 kJ*mol⁻¹). [3, 25] Our experimental data shows the CH₄ conversion is slightly lower than that of CO₂ and CO formation is higher than H₂ during the temperature range. The result indicates the RWGS reaction is present in our study.

FIGS. 4A and 4B compare the conversion of CH₄ and CO₂ for 3 wt. % Ni dispersed on CeO₂, Ce_{0.7}Ti_{0.3}O_{2-δ}, and Ce_{0.5}Ti_{0.5}O_{2-δ} with selected Ce/Ti ratios. As a contrast experiment, the DRM reaction was first performed over pure Ce_{0.7}Ti_{0.3}O_{2-δ} with no Ni loading. Little methane conversion was observed below 700° C. This is consistent with the absence of active Ni metal sites for methane activation. A small amount of methane conversion (5%) was detected at 800° C., which is likely the result of the thermal decomposition of methane (CH₄→2H₂+C, ΔH_{298K}=+75kJ*mol⁻¹). 10% of CO₂ conversion was observed at 800° C. over the support. All Ni samples (Ni/CeO₂, Ni/Ce_{0.7}Ti_{0.3}O_{2-δ}, and Ni/Ce_{0.5}Ti_{0.5}O_{2-δ}) exhibit DRM activity, which increases with the reaction temperature. However, these catalysts activate the DRM reaction at different temperatures. The Ni/CeO₂ catalyst shows the DRM activity around 350° C. The DRM activity was not observed to a measurable degree until 450° C. over Ni/Ce_{0.7}Ti_{0.3}O_{2-δ} and a much higher temperature of 650° C. over Ni/Ce_{0.5}Ti_{0.5}O_{2-δ}. The Ni/CeO₂ catalyst delivers the highest conversion and product yield up to the temperature of 600° C. At 600° C., Ni/CeO₂ and Ni/Ce_{0.7}Ti_{0.3}O_{2-δ} exhibit a similar behavior with the CH₄ and CO₂ conversions of 34% and 39% and the H₂ and CO yields of 30% and 36%. With further increase of the temperature from 600 to 800° C., the Ni/Ce_{0.7}Ti_{0.3}O_{2-δ} shows a better activity. Little DRM activity was shown over Ni/Ce_{0.5}Ti_{0.5}O_{2-δ} until 650° C. However, the activity increases sharply at 700° C. and reaches that of Ni/CeO₂. At 800° C., it shows a slightly better performance compared to Ni/CeO₂. The H₂/CO ratios were calculated and are shown in FIG. 4E. The H₂/CO ratio of Ni/CeO₂ increases to 0.88 when the reaction temperature ramps to 550° C. However, it drops continuously and reaches 0.72 with further increase of the temperature to 650° C. followed by an increase again to 0.93 at 800° C. The H₂/CO ratio measured over Ni/Ce_{0.5}Ti_{0.5}O_{2-δ} is 0.19 at 650° C., which is the result of the low DRM activity. It increases rapidly to 0.79 at 700° C. and 0.97 at 800° C. The Ni/Ce_{0.7}Ti_{0.3}O_{2-δ} sample shows a consistent increasing trend of the H₂/CO ratio over the entire temperature range. The H₂/CO ratio is 0.92 at 700° C. and close to unity at 800° C. It has been shown that major side reactions in DRM including RWGS, Boudouard reaction, and methane decomposition were favorable to occur in the temperature range between 550 and 700° C., which can influence the conversions of CH₄ and CO₂, H₂ and CO yields, as well as corresponding H₂/CO ratio. [64] Our data suggest that Ni over the ceria support with the Ce/Ti ratio of 7/3 shows a promising DRM activity with a reduced extent of side reactions.

The DRM reaction over Ni/CeO₂ has been investigated and in general, Ni/CeO₂ catalyst shows less than 40% conversion of methane at 650° C. [65, 66] Higher methane conversion of -60% can be obtained over Ni supported over ceria with a specific morphology, like nanorods. [67] In our study, Ni supported on CeO₂ displays the methane conversion of 40%. However, Ni supported on Ce_{0.7}Ti_{0.3}O_{2-δ} has a higher conversion of 54%. With further increase of Ti composition to 0.5 in Ce_{0.5}Ti_{0.5}O_{2-δ}, the supported Ni only shows a 2% methane conversion under the same condition. At a higher temperature of 750° C., the methane conversion for Ni supported on CeO₂, Ce_{0.7}Ti_{0.3}O_{2-δ}, and Ce_{0.5}Ti_{0.5}O_{2-δ} increase to 71%, 83%, and 72%. The Ni/Ce_{0.7}Ti_{0.3}O_{2-δ} catalysts in our study shows a promising activity under DRM conditions compared to reported results of other active metal catalysts or Ni supported over different oxides. [1, 13, 17, 66, 68, 69]

FIG. 3C shows the XRD pattern of 3 wt. % Ni loading on different ceria supports after the DRM test. There is a significant difference in the XRD patterns associated with the ceria supports. Little change in the Ni/CeO2XRD pattern was observed after DRM. However, for Ni on Ce_{0.5}Ti_{0.5}O_{2-δ}, intense diffraction peaks at 21.3°, 30.0°, 40.2°, 43.2°, 46.8°, 55.3° and 58.3° corresponding to (210), (112), (022), (420), (1̅04), (304) and (232) of a new phase of Ce₂Ti₂O7 (JCPDS 47-0667) is formed and the peaks related with CeO₂ are significantly reduced in intensity. [70] The data suggest there is a phase change between Ce_{0.5}Ti_{0.5}O_{2-δ} containing segregated TiO₂ and Ce₂Ti₂O7 during the DRM reaction, which is accompanied with a reduction of Ce⁴⁺→Ce³⁺. For Ni on Ce_{0.7}Ti_{0.3}O_{2-δ}, the formation of new phase Ce₂Ti₂O7 is also suggested. However, the predominant XRD peaks are associated with CeO₂. The XRD data of Ni over CeO₂ and Ce_{0.7}Ti_{0.3}O_{2-δ} suggest these samples largely maintain the ceria structure during the DRM process. In contrast, Ni over Ce_{0.5}Ti_{0.5}O_{2-δ} produces the Ce₂Ti₂O7 phase as a result of a reduction of Ce⁴⁺→Ce³⁺ during the reaction. In all three spent samples, additional XRD peaks located at 44.4° and 51.9° that are associated with metallic Ni (JCPDS 04-0850) were observed, which increase in the intensity with the amount of Ti doping in ceria. [71] The data is consistent with the suggestion that metallic Ni is the active species for DRM. There are no observable XRD peaks associated with deposited Ni among all the fresh catalysts. The presence of Ni XRD patterns in the spent samples could be due to the result of particle aggregation to form bigger sizes with heating during the DRM reaction and the nature of the ceria support can play an important role in that regard.

3.2 The Effect of Ni Weight Loadings

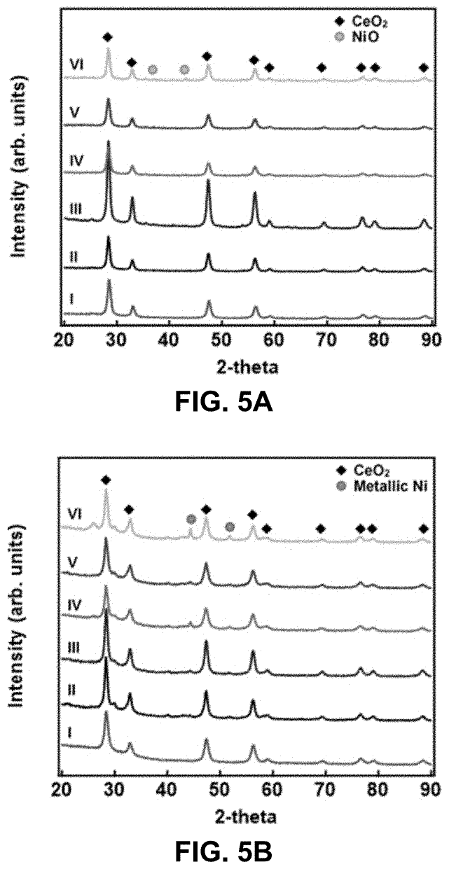

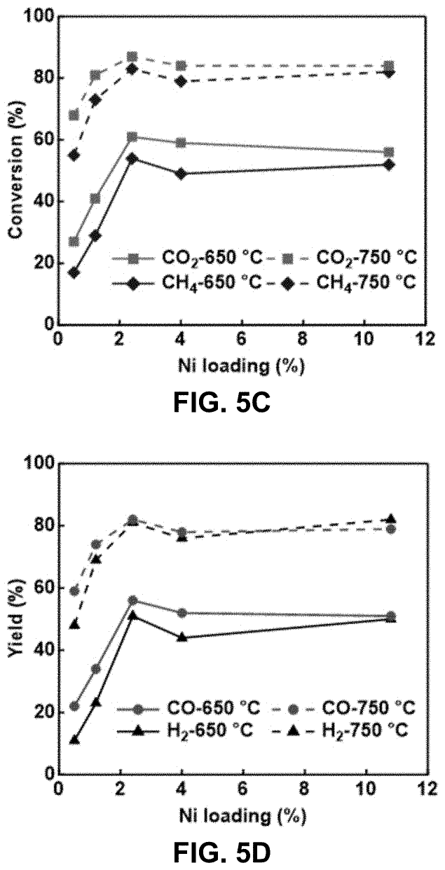

Ni loadings were varied during the catalyst synthesis to tune the optimum DRM performance. XRD patterns (FIG. 5A) were collected from as-prepared 0.5-10.8 wt. % Ni over the Ce_{0.7}Ti_{0.3}O_{2-δ} support. The indicated weight loading values of Ni were determined by ICP measurements. The Ce_{0.7}Ti_{0.3}O_{2-δ} support was selected due to the promotion in the DRM activity over supported Ni as discussed above. From 0.5 to 4.0 wt. % Ni loadings, the XRD patterns are similar to that of pure support, indicating Ni particles are well dispersed on the support. With further increase of Ni loadings to 10.8 wt. % on the support, new peaks at 37.1° and 43.1° are clearly shown in FIG. 5A. These peaks match well to the (111) and (200) planes of NiO (JCPDS 47-1049), suggesting the formation of NiO on Ce_{0.7}Ti_{0.3}O_{2-δ}. [71] The amount of Ni added does not affect the lattice constant of ceria significantly, indicating that Ni anchors on the support surface other than permeating into the lattice. Based on the XRD data, the average crystallite size of NiO increases with respect to the Ni loading and the particle size was determined to be 24 nm for the 10.8 wt. % Ni supported over Ce_{0.7}Ti_{0.3}O_{2-δ}.

The DRM reaction is favored at high temperatures and it is not spontaneous at temperatures lower than 643° C. Coke formation is especially prominent in DRM between 550 and 700° C. due to the Boudouard reaction and methane decomposition. Therefore, it has been suggested that a desirable temperature range for the DRM process is 643-1027° C. with the pressure close to atmospheric. [2] FIGS. 5C and 5D compare the results of various Ni loadings between 0.5 and 10.8 wt. % on Ce_{0.7}Ti_{0.3}O_{2-δ} for the dry reforming of methane at two represented reaction temperatures of 650 and 750° C. The increase in the nickel loading from 0.5 to 2.4 wt. % results in a rapid increase in the CH₄ and CO₂ conversions. As shown, CH₄ conversion increases from 17% to 54% and CO₂ conversion increased from 27% to 61% at 650° C. Correspondingly, the product yields of H₂ and CO were increased from 11% and 22% to 51% and 56%, respectively. Further increase of the Ni loading does not increase the DRM activity. Similar activity trends with respect to the Ni loadings were also observed at 750° C. The results clearly show that 2.4 wt. % Ni supported on Ce_{0.7}Ti_{0.3}O_{2-δ} exhibits the best DRM activity despite the sample having a relatively low measured surface area of 26 m²/g and Ni metal surface area of 4.8 m²/g of nickel. Previous studies have demonstrated that the SMSI plays an important role in the reactivity of ceria-supported Ni. [72-74] Ni particles being in strong interactions with ceria supports are not easily subjected to form agglomerates and smaller Ni particles can effectively inhibit the coke formation. The better activity over 2.4 wt. % Ni supported on Ce_{0.7}Ti_{0.3}O_{2-δ} is likely due to the strong Ni-ceria interaction and formation of smaller Ni particles at this weight loading. XPS and TEM studies will be used to further investigate the interaction of Ni with respect to the nature of the support in our future study. XRD studies of spent samples suggest that metallic Ni is formed as evident with the peaks at 44.4° and 51.9° (FIG. 5B).

3.3 Stability Tests

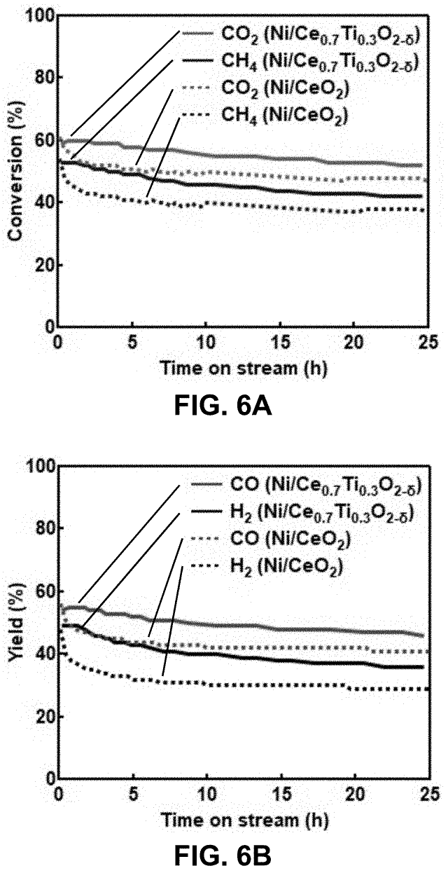

The stability test of the 2.4 wt. % Ni/Ce_{0.7}Ti_{0.3}O_{2-δ} sample for DRM was carried out at 650° C. as a function of time on stream and the result was compared to that of 3.1 wt. % Ni/CeO₂ (FIGS. 6A-6B). Both samples were prepared with a nominal Ni loading of 3 wt. %. At the start of the reaction, the CH₄ and CO₂ conversion over Ni/CeO₂ is 54% and 61% and the H₂ and CO yield is 48% and 56%, respectively. The sample lost DRM activity quickly within the first 5 hours and dropped a total of 17 and 14 percentage points in CH₄ and CO₂ conversion and 19 and 15 percentage points in H₂ yield during the course of the 25-hour reaction. Compared to CeO₂-supported Ni, Ni/Ce_{0.7}Ti_{0.3}O_{2-δ} shows much better stability. Doping Ti into ceria and the Ce:Ti ratio in Ce₁₋ₓTiₓO_{2-δ} can affect the DRM activity and stability of supported Ni. Out data indicate that an optimum result was obtained for Ni over Ce₁₋ₓTiₓO_{2-δ} with a Ti/Ce ratio of 3/7. Similar behavior was also observed for the DRM study of Ni supported over ceria doped with other metal elements. [75-77] The thermogravimetric analysis (TGA) of spent Ni/Ce_{0.7}Ti_{0.3}O_{2-δ} sample (data not shown) indicates there is 27% weight loss due to the formation of carbon during the DRM reaction. Most of the weight loss occurs at temperature less than 650° C., suggesting formation of amorphous carbon and surface carbide. [78, 79] These carbon species are active during the DRM reaction as they can serve as a reaction intermediate and assist in the formation of CO. [80] This explains the sustained DRM reactivity and good stability of Ni supported over Ce_{0.7}Ti_{0.3}O_{2-δ} in our study. The SEM images of the Ni/Ce_{0.7}Ti_{0.3}O_{2-δ} catalyst after 30 min and 50 h dry reforming of methane reaction are presented in FIGS. 3G and 3H. The morphology of these catalysts shows differences compared to the fresh Ni/Ce_{0.7}Ti_{0.3}O_{2-δ} catalyst. Loose-type structures were observed over the catalyst surface after the reaction, which is consistent with the formation of carbon deposit as suggested by TGA data.

This high activity and stability of the Ni/Ce_{0.7}Ti_{0.3}O_{2-δ} catalyst can be understood by examining the reaction mechanism. The CH₄ dissociates on the active Ni sites to form reactive carbon atoms with hydrogen atoms recombining and desorbing from the surface as H₂. [73] Ceria, as a highly basic support, is active toward CO₂. CO₂ activation can occur on the oxide support and/or at the Ni-oxide interfaces to form CO+O. CO then desorbs from the catalyst surface. During the reaction, oxygen from CO₂ decomposition can further recombine with surface C from Ni sites and desorb as CO. Additionally, oxygen could be released from the ceria lattice and react with C from Ni as a result of the redox properties and oxygen storage capacity of ceria. Removal of C from Ni can help reduce the accumulation of C deposits and thus the deactivation of Ni. Our data show that addition of Ti⁴⁺ ions in ceria can promote the DRM activity and stability of Ni. This is consistent with the suggestion of the enhancement of the redox properties and oxygen storage capacities of ceria by Ti doping, which can result in a stronger metal-support interaction. [81-83] Further XPS and temperature-programmed reduction/oxidation experiments are underway to elucidate the nature of the oxygen storage capacity and redox properties of ceria with respect to Ti/Ce ratios.

4. Conclusions

Ce₁₋ₓTiₓO_{2-δ} mixed oxides were synthesized with high Ce/Ti ratios. The activity of Ni depends on the Ce/Ti ratios in Ce₁₋ₓTiₓO_{2-δ}, Ni loadings, and temperatures and 2.4 wt. % Ni over Ce_{0.7}Ti_{0.3}O_{2-δ} shows promising reactivity and stability. In some embodiments, Ni is the active metal species in dry reforming of methane. We observed a new phase of Ce₂Ti₂O7 forms in dry reforming of methane over Ni/Ce_{0.5}Ti_{0.5}O_{2-δ}.

Ce₁₋ₓTiₓO_{2-δ} supports were synthesized using the sol-gel method and the formation of Ce₁₋ₓTiₓO_{2-δ} mixed oxides can be obtained with high Ce/Ti ratios. Nickel with 0.5-10 wt. % loadings over Ce₁₋ₓTiₓO_{2-δ} were prepared by the impregnation method. Small nanoparticles of Ni were dispersed on the surface of the support, which increases the size with respect to the weight loading. Our data have demonstrated that the DRM performance of supported Ni is dependent on the Ti concentrations in the ceria support, Ni loadings, and reaction temperatures. The 2.4 wt. % Ni supported on Ce_{0.7}Ti_{0.3}O_{2-δ} exhibits the best catalytic result. It shows initial DRM reactivity around 350° C. and delivers CH₄ and CO₂ conversions of 54% and 61% at 650° C., which increase to 92% and 94% with the H₂/CO ratio close to unity when further increasing the temperature to 800° C. Only 11 percentage points of CH₄ conversion activity was lost within a 25 h reaction compared to 17 percentage points activity loss from Ni/CeO₂ despite the formation of C on the catalyst surface. Our data further suggest that metallic Ni is the active species and reduction of ceria occurs during DRM. For Ni supported on Ce₁₋ₓTiₓO_{2-δ} mixed oxides with lower Ce/Ti ratios, like Ce_{0.5}Ti_{0.5}O_{2-δ}, a new phase of Ce₂Ti₂O7 is formed during DRM. Doping of Ti in ceria can modify physical and electronic properties of ceria that can tune the activity and stability of supported Ni in the DRM reaction.

### REFERENCES ASSOCIATED WITH EXAMPLE 2

1. Pakhare, D., Spivey, J., A Review of Dry (CO₂) Reforming of Methane over Noble Metal Catalysts. Chemical Society Reviews, 2014, 43, (22), 7813-7837.

2. Arora, S., Prasad, R., An Overview on Dry Reforming of Methane: Strategies to Reduce Carbonaceous Deactivation of Catalysts, RSC Advances., 6 (2016) 108668-108688.

3. Haynes, W. M., CRC Handbook of Chemistry and Physics, 97th Edition, (2016).

4. Winter, C. J., Hydrogen Energy-Abundant, Efficient, Clean: A Debate over the Energy-System-of-Change, Int. J. Hydrogen Energy, 34 (2009) S1-S52.

5. Martin, M. M., Chapter 5—Syngas, in: M. M. Martin (Ed.) Industrial Chemical Process Analysis and Design, Elsevier, Boston, 2016, pp. 199-297.

6. Lavoie, J. M., Review on Dry Reforming of Methane, A Potentially More Environmentally-Friendly Approach to the Increasing Natural Gas Exploitation, Frontiers in Chemistry, 2 (2014) 1-17.

7. Pitchai, R., Klier, K., Partial Oxidation of Methane, Catalysis Reviews—Science and Engineering, 28 (1986) 13-88.

8. lulianelli, A., Liguori, S., Wilcox, J., Basile, A., Advances on Methane Steam Reforming to Produce Hydrogen Through Membrane Reactors Technology: A Review, Catalysis Reviews—Science and Engineering, 58 (2016) 1-35.

9. Jahangiri, H., Bennett, J., Mahjoubi, P., Wilson, K., Gu, S., A Review of Advanced Catalyst Development for Fischer-Tropsch Synthesis of Hydrocarbons From Biomass Derived Syn-Gas, Catalysis Science & Technology, 4 (2014) 2210-2229.

10. Ross, J. R. H, Natural Gas Reforming and CO₂ Mitigation, Catalysis Today, 100 (2005) 151-158.

11. Seo, H. O., Recent Scientific Progress on Developing Supported Ni Catalysts for Dry (CO₂) Reforming of Methane, Catalysts, 8 (2018) 18.

12. Mohamedali, M., Henni, A., Ibrahim, H., Recent Advances in Supported Metal Catalysts for Syngas Production from Methane, Chem Engineering, 2 (2018) 9.

13. Yentekakis, I. V., Goula, G., Hatzisymeon, M., Betsi-Argyropoulou, I., Botzolaki, G., Kousi, K., Kondarides, D. I., Taylor, M. J., Parlett, C. M. A., Osatiashtiani, A., Kyriakou, G., Holgado, J. P., Lambert, R. M., Effect of Support Oxygen Storage Capacity on the Catalytic Performance of Rh Nanoparticles for CO₂ Reforming of Methane, Applied Catalysis B: Environmental, 243 (2019) 490-501.

14. Wang, H. Y., Ruckenstein, E., Carbon Dioxide Reforming of Methane to Synthesis Gas over Supported Rhodium Catalysts: the Effect of Support, Applied Catalysis A: General, 204 (2000) 143-152.

15. Aziz, M. A. A., Jalil, A. A., Wongsakulphasatch, S., Vo, D. V. N., Understanding the Role of Surface Basic Sites of Catalysts in CO₂ Activation in Dry Reforming of Methane: A Short Review, Catalysis Science & Technology, 10 (2020) 35-45.

16. Wang, S. B., Lu, G. Q. M., Millar, G. J., Carbon Dioxide Reforming of Methane to Produce Synthesis Gas over Metal-Supported Catalysts: State of the Art, Energy Fuels, 10 (1996) 896-904.

17. Abdullah, B., Ghani, N. A. A., Vo, D. V. N., Recent Advances in Dry Reforming of Methane over Ni-Based Catalysts, Journal of Cleaner Production, 162 (2017) 170-185.

18. Munera, J. F., Cornaglia, L. M., Cesar, D. V., Schmal, M., Lombardo, E. A., Kinetic Studies of the Dry Reforming of Methane over the Rh/La₂O₃—SiO₂ Catalyst, Industrial & Engineering Chemistry Research, 46 (2007) 7543-7549.

19. Ferreira-Aparicio, P., Marquez-Alvarez, C., Rodriguez-Ramos, I., Schuurman, Y., Guerrero-Ruiz, A., Mirodatos, C., A Transient Kinetic Study of the Carbon Dioxide Reforming of Methane over Supported Ru Catalysts, Journal of Catalysis, 184 (1999) 202-212.

20. Garcia-Dieguez, M., Pieta, I. S., Herrera, M. C., Larrubia, M. A., Alemany, L. J., Nanostructured Pt- and Ni-Based Catalysts for CO₂-Reforming of Methane, Journal of Catalysis, 270 (2010) 136-145.

21. Liu, Z. Y., Zhang, F., Rui, N., Li, X., Lin, L. L., Betancourt, L. E., Su, D., Xu, W. Q., Cen, J. J., Attenkofer, K., Idriss, H., Rodriguez, J. A., Senanayake, S. D., Highly Active Ceria-Supported Ru Catalyst for the Dry Reforming of Methane: In Situ Identification of Ru^{δ+}—Ce³⁺ Interactions for Enhanced Conversion, ACS Catalysis, 9 (2019) 3349-3359.

22. Liu, Z. Y., Grinter, D. C., Lustemberg, P. G., Nguyen-Phan, T. D., Zhou, Y. H., Luo, S., Waluyo, I., Crumlin, E. J., Stacchiola, D. J., Zhou, J., Carrasco, J., Busnengo, H. F., Ganduglia-Pirovano, M. V., Senanayake, S. D., Rodriguez, J. A., Dry Reforming of Methane on a Highly-Active Ni—CeO₂ Catalyst: Effects of Metal-Support Interactions on C-H Bond Breaking, Angewandte Chemie International Edition, 55 (2016) 7455-7459.

23. Argyle, M. D., Bartholomew, C. H., Heterogeneous Catalyst Deactivation and Regeneration: A Review, Catalysts, 5 (2015) 145-269.

24. Pompeo, F., Nichio, N. N., Souza, M. M. V. M., Cesar, D. V., Ferretti, O. A., Schmal, M., Study of Ni and Pt Catalysts Supported on α-Al₂O₃ and ZrO₂ Applied in Methane Reforming with CO₂, Applied Catalysis A: General, 316 (2007) 175-183.

25. Shinde, V. M., Madras, G., Catalytic Performance of Highly Dispersed Ni/TiO₂ for Dry and Steam Reforming of Methane, RSC Advances, 4 (2014) 4817-4826.

26. Wang, C. Z., Jie, X. Y., Qiu, Y., Zhao, Y. X., Al-Megren, H. A., Alshihri, S., Edwards, P. P., Xiao, T. C., The Importance of Inner Cavity Space within Ni@SiO₂ Nanocapsule Catalysts for Excellent Coking Resistance in the High-Space-Velocity Dry Reforming of Methane, Applied Catalysis B: Environmental, 259 (2019).

27. Guo, J. J., Lou, H., Zhao, H., Chai, D. F., Zheng, X. M., Dry Reforming of Methane over Nickel Catalysts Supported on Magnesium Alum inate Spinets, Applied Catalysis A: General, 273 (2004) 75-82.

28. Zhang, M., Zhang, J. F., Zhou, Z. L., Chen, S. Y., Zhang, T., Song, F. E., Zhang, Q. D., Tsubaki, N., Tan, Y. S., Han, Y. Z., Effects of the Surface Adsorbed Oxygen Species Tuned by Rare-Earth Metal Doping on Dry Reforming of Methane over Ni/ZrO₂ Catalyst, Applied Catalysis B: Environmental, 264 (2020) 118666.

29. Lima, S. M., Assaf, J. M., Pena, M. A., Fierro, J. L. G., Structural Features of La₁₋ₓCeₓNiO₃ Mixed Oxides and Performance for the Dry Reforming of Methane,

Applied Catalysis A: General, 311 (2006) 94-104.

30. Djinovic, P., Batista, J., Pintar, A., Efficient Catalytic Abatement of Greenhouse Gases: Methane Reforming with CO₂ Using a Novel and Thermally Stable Rh—CeO₂ Catalyst, International Journal of Hydrogen Energy, 37 (2012) 2699-2707.

31. Damyanova, S., Pawelec, B., Arishtirova, K., Huerta, M. V. M., Fierro, J. L. G., The Effect of CeO₂ on the Surface and Catalytic Properties of Pt/CeO₂—ZrO₂ Catalysts for Methane Dry Reforming, Applied Catalysis B: Environmental, 89 (2009) 149-159.

32. Xie, Z. H., Yan, B. H., Kattel, S., Lee, J. H., Yao, S. Y., Wu, Q. Y., Rui, N., Gomez, E., Liu, Z. Y., Xu, W. Q., Zhang, L., Chen, J. G. G., Dry Reforming of Methane over CeO₂-Supported Pt—Co Catalysts with Enhanced Activity, Applied Catalysis B: Environmental, 236 (2018) 280-293.

33. Graciani, J., Mudiyanselage, K., Xu, F., Baber, A. E., Evans, J., Senanayake, S. D., Stacchiola, D. J., Liu, P., Hrbek, J., Sanz, J. F., Rodriguez, J. A., Highly Active Copper-Ceria and Copper-Ceria-Titania Catalysts for Methanol Dynthesis from CO₂, Science, 345 (2014) 546-550.

34. Wang, F., Li, C. M., Zhang, X. Y., Wei, M., Evans, D. G., Duan, X., Catalytic Behavior of Supported Ru Nanoparticles on the {100}, {110}, and {111} Facet of CeO₂, Journal of Catalysis, 329 (2015) 177-186.

35. Ay, H., Under, D., Dry Reforming of Methane over CeO₂ Supported Ni, Co and Ni—Co Catalysts, Applied Catalysis B: Environmental, 179 (2015) 128-138.

36. Senanayake, S. D., Evans, J., Agnoli, S., Barrio, L., Chen, T.L., Hrbek, J., Rodriguez, J. A., Water-Gas Shift and CO Methanation Reactions over Ni—CeO₂(111) Catalysts, Topics in Catalysis, 54 (2011) 34-41.

37. Senanayake, S. D., Ramirez, P. J., Waluyo, I., Kundu, S., Mudiyanselage, K., Liu, Z. Y., Liu, Z., Axnanda, S., Stacchiola, D. J., Evans, J., Rodriguez, J. A., Hydrogenation of CO₂ to Methanol on CeOₓ/Cu(111) and ZnO/Cu(111) Catalysts: Role of the Metal-Oxide Interface and Importance of Ce³⁺ Sites, The Journal of Physical Chemistry C, 120 (2016) 1778-1784.

38. Gonzalez-DelaCruz, V. M., Holgado, J. P., Pereniguez, R., Caballero, A., Morphology Changes Induced by Strong Metal-Dupport Interaction on a Ni-Ceria Catalytic System, Journal of Catalysis, 257 (2008) 307-314.

39. Cai, W. J., Ye, L., Zhang, L., Ren, Y. H., Yue, B., Chen, X. Y., He, H. Y., Highly Dispersed Nickel-Containing Mesoporous Silica with Superior Stability in Carbon Dioxide Reforming of Methane: The Effect of Anchoring, Materials, 7 (2014) 2340-2355.

40. Yan, B. H., Yang, X. F., Yao, S. Y., Wan, J., Myint, M., Gomez, E., Xie, Z. H., Kattel, S., Xu, W. Q., Chen, J. G. G., Dry Reforming of Ethane and Butane with CO₂ over PtNi/CeO₂ Bimetallic Catalysts, ACS Catalysis, 6 (2016) 7283-7292.

41. Siahvashi, A., Adesina, A. A., Kinetic Study of Propane CO₂ Reforming over Bimetallic Mo—Ni/Al₂O₃ Catalyst, Industrial & Engineering Chemistry Research, 52 (2013) 15377-15386.

42. Xie, Z. H., Yan, B. H., Lee, J. H., Wu, Q. Y., Li, X., Zhao, B. H., Su, D., Zhang, L., Chen, J. G. G., Effects of Oxide Supports on the CO₂ Reforming of Ethane over Pt-Ni Bimetallic Catalysts, Applied Catalysis B: Environmental, 245 (2019) 376-388.

43. Luisetto, I., Tuti, S., Di Bartolomeo, E., Co and Ni Supported on CeO₂ as Selective Bimetallic Catalyst for Dry Reforming of Methane, International Journal of Hydrogen Energy, 37 (2012) 15992-15999.

44. Luisetto, I., Tuti, S., Romano, C., Boaro, M., Di Bartolomeo, E., Dry Reforming of Methane over Ni Supported on Doped CeO₂: New Insight on the Role of Dopants for CO₂ Activation, Journal of CO₂ Utilization, 30 (2019) 63-78.

45. Damaskinos, C. M., Vasiliades, M. A., Efstathiou, A. M., The Effect of Ti⁴⁺ Dopant in the 5 wt. % Ni/Ce₁₋ₓTiₓO_{2-δ} Catalyst on the Carbon Pathways of Dry Reforming of Methane Studied by Various Transient and Isotopic Techniques, Applied Catalysis A: General, 579 (2019) 116-129.

46. Montini, T., Melchionna, M., Monai, M., Fornasiero, P., Fundamentals and Catalytic Applications of CeO₂-Based Materials, Chemical Reviews, 116 (2016) 5987-6041.

47. Figueroba, A., Bruix, A., Kovacs, G., Neyman, K. M., Metal-Doped Ceria Nanoparticles: Stability and Redox Processes, Physical Chemistry Chemical Physics, 19 (2017) 21729-21738.

48. Lin, F. J., Alxneit, I., Wokaun, A., Structural and Chemical Changes of Zn-Doped CeO₂ Nanocrystals upon Annealing at Ultra-High Temperatures, CrystEngComm, 17 (2015) 1646-1653.

49. Chen, W. T., Chen, K. B., Wang, M. F., Weng, S. F., Lee, C. S., Lin, M. C., Enhanced Catalytic Activity of Ce₁₋ₓMₓO₂ (M=Ti, Zr, and Hf) Solid Solution with Controlled Morphologies, Chemical Communications, 46 (2010) 3286-3288.

50. Liu, Y., Wen, C., Guo, Y., Lu, G. Z., Wang, Y. Q., Modulated CO Oxidation Activity of M-Doped Ceria (M=Cu, Ti, Zr, and Tb): Role of the Pauling Electronegativity of M, The Journal of Physical Chemistry C, 114 (2010) 9889-9897.

51. Yu, Y., Zhong, L., Ding, J., Cai, W., Zhong, Q., Cobalt Supported on Metal-Doped Ceria Catalysts (M=Zr, Sn and Ti) for NO Oxidation, RSC Advances, 5 (2015) 23193-23201.

52. Watanabe, S., Ma, X. L., Song, C. S., Characterization of Structural and Surface Properties of Nanocrystalline TiO₂—CeO₂ Mixed Oxides by XRD, XPS, TPR, and TPD, The Journal of Physical Chemistry C, 113 (2009) 14249-14257.

53. Zhang, F., Liu, Z. Y., Chen, X.B., Rui, N., Betancourt, L. E., Lin, L. L., Xu, W. Q., Sun, C. J., Abeykoon, A. M. M., Rodriguez, J. A., Terzan, J., Lorber, K., Djinovic, P., Senanayake, S. D., Effects of Zr Doping into Ceria for the Dry Reforming of Methane over Ni/CeZrO₂ Catalysts: In Situ Studies with XRD, XAFS, and AP-XPS, ACS Catalysis, 10 (2020) 3274-3284.

54. Nakayama, M., Martin, M., First-Principles Study on Defect Chemistry and Migration of Oxide Ions in Ceria Doped with Rare-Earth Cations, Physical Chemistry Chemical Physics, 11 (2009) 3241-3249.

55. Zhou, Y. H., Zhou, J., Growth and Surface Structure of Ti-Doped CeOₓ(111) Thin Films, The Journal of Physical Chemistry Letters, 1 (2010) 1714-1720.

56. Nolan, M., Molecular Adsorption on the Doped (110) Ceria Surface, The Journal of Physical Chemistry C, 113 (2009) 2425-2432.

57. Petallidou, K. C., Polychronopoulou, K., Boghosian, S., Garcia-Rodriguez,

S., Efstathiou, A. M., Water-Gas Shift Reaction on Pt/Ce₁₋ₓTiₓO_{2-δ}: The Effect of Ce/Ti Ratio, The Journal of Physical Chemistry C, 117 (2013) 25467-25477.

58. Kim, S. S., Lee, S. M., Won, J. M., Yang, H. J., Hong, S. C., Effect of Ce/Ti Ratio on the Catalytic Activity and Stability of Ni/CeO₂—TiO₂ Catalyst for Dry Reforming of Methane, Chemical Engineering Journal, 280 (2015) 433-440.

59. Du, L., Ginting, E., Zhou, J., Morphology and Chemical States of Ni Supported on Ti-Modified CeOₓ(111) Interfaces, Surf. Sci., 699 (2020) 121624.

60. Zhou, Y., Zhou, J., Ti/CeOₓ(111) Interfaces Studied by XPS and STM, Surface Science, 606 (2012) 749-753.

61. Djaidja, A., Libs, S., Kiennemann, A., Barama, A., Characterization and Activity in Dry Reforming of Methane on NiMg/Al and Ni/MgO Catalysts, Catalysis Today, 113 (2006) 194-200.

62. Wolfbeisser, A., Sophiphun, O., Bernardi, J., Wittayakun, J., Fottinger, K., Rupprechter, G., Methane Dry Reforming over Ceria-Zirconia Supported Ni Catalysts, Catalysis Today, 277 (2016) 234-245.

63. Shannon, R. D., Revised Effective Ionic-Radii and Systematic Studies of Interatomic Distances in Halides and Chalcogenides, Acta Crystallographica Section A, 32 (1976) 751-767.

64. Amin, M., A Mini-Review on CO₂ Reforming of Methane, Progress in Petrochemical Science, 2 (2018).

65. Du, X. J., Zhang, D. S., Shi, L. Y., Gao, R. H., Zhang, J. P., Morphology Dependence of Catalytic Properties of Ni/CeO₂ Nanostructures for Carbon Dioxide Reforming of Methane, The Journal of Physical Chemistry C, 116 (2012) 10009-10016.

66. Araiza, D. G., Arcos, D. G., Gomez-Cortes, A., Diaz, G., Dry Reforming of Methane over Pt—Ni/CeO₂ Catalysts: Effect of the Metal Composition on the Stability, Catalysis Today, (2019).

67. Wang, N., Qian, W. Z., Chu, W., Wei, F., Crystal-Plane Effect of Nanoscale CeO₂ on the Catalytic Performance of Ni/CeO₂ Catalysts for Methane Dry Reforming, Catalysis Science & Technology, 6 (2016) 3594-3605.

68. Chang, K., Zhang, H. C., Chen,g, M. J., Lu, Q., Application of Ceria in CO₂ Conversion Catalysis, ACS Catalysis, 10 (2020) 613-631.

69. Hassani Rad, S. J., Haghighi, M., Alizadeh Eslami, A., Rahmani, F., Rahemi, N., Sol-Gel vs. Impregnation Preparation of MgO and CeO₂ Doped Ni/Al₂O₃ Nanocatalysts Used in Dry reforming of Methane: Effect of Process Conditions, Synthesis Method and Support Composition, International Journal of Hydrogen Energy, 41 (2016) 5335-5350.

70. Preuss, A., Gruehn, R., Preparation and Structure of Cerium Titanates Ce₂TiO₅, Ce₂Ti₂O₇, and Ce₄Ti₉O₂₄, Journal of Solid State Chemistry, 110 (1994) 363-369.

71. Jovic, V. D., Maksimovic, V., Pavlovic, M. G., Popov, K. I., Morphology, Internal Tructure and Growth Mechanism of Electrodeposited Ni and Co Powders, Journal of Solid State Electrochemistry, 10 (2006) 373-379.

72. Xu, W. Q., Liu, Z. Y., Johnston-Peck, A. C., Senanayake, S. D., Zhou, G., Stacchiola, D., Stach, E. A., Rodriguez, J. A., Steam Reforming of Ethanol on Ni/CeO₂: Reaction Pathway and Interaction between Ni and the CeO₂ Support, ACS Catalysis, 3 (2013) 975-984.

73. Lustemberg, P. G., Ramirez, P. J., Liu, Z. Y., Gutierrez, R. A., Grinter, D. G., Carrasco, J., Senanayake, S. D., Rodriguez, J. A., Ganduglia-Pirovano, M. V., Room-Temperature Activation of Methane and Dry Re-forming with CO₂ on Ni—CeO₂(111) Surfaces: Effect of Ce³⁺ Sites and Metal-Support Interactions on C—H Bond Cleavage, ACS Catalysis, 6 (2016) 8184-8191.

74. Liu, Z. Y., Duchon, T., Wang, H. R., Grinter, D. C., Waluyo, I., Zhou, J., Liu, Q., Jeong, B., Crumlin, E. J., Matolin, V., Stacchiola, D. J., Rodriguez, J. A., Senanayake, S. D., Ambient Pressure XPS and IRRAS Investigation of Ethanol Steam Reforming on Ni—CeO₂(111) Catalysts: An In Situ Study of C—C and O—H Bond Scission, Physical Chemistry Chemical Physics, 18 (2016) 16621-16628.

75. Munoz, M. A., Calvino, J. J., Rodriguez-Izquierdo, J. M., Blanco, G., Arias, D. C., Perez-Omit, J. A., Hernandez-Garrido, J. C., Gonzalez-Leal, J. M., Cauqui, M. A., Yeste, M. P., Highly Stable Ceria-Zirconia-Yttria Supported Ni Catalysts for Syngas Production by CO₂ Reforming of Methane, Applied Surface Science, 426 (2017) 864-873.

76. Kumar, P., Sun, Y., Idem, R. O., Nickel-Based Ceria, Zirconia, and Ceria-Zirconia Catalytic Systems for Low-Temperature Carbon Dioxide Reforming of Methane, Energy Fuels, 21 (2007) 3113-3123.

77. Kambolis, A., Matralis, H., Trovarelli, A., Papadopoulou, C., Ni/CeO₂-ZrO₂ Catalysts for the Dry Reforming of Methane, Applied Catalysis A: General, 377 (2010) 16-26.

78. Lehman, J. H., Terrones, M., Mansfield, E., Hurst, K. E., Meunier, V., Evaluating the Characteristics of Multiwall Carbon Nanotubes, Carbon, 49 (2011) 2581-2602.

79. Lima, A. M. F., Musumeci, A. W., Liu, H.-W., Waclawik, E. R., Silva, G. G., Purity Evaluation and Influence of Carbon Nanotube on Carbon Nanotube/Graphite Thermal Stability, Journal of Thermal Analysis and calorimetry, 97 (2009).

80. Yan, X. L., Hu, T., Liu, P., Li, S., Zhao, B. R., Zhang, Q., Jiao, W. Y., Chen, S., Wang, P. F., Lu, J. J., Fan, L. M., Deng, X. N., Pan, Y. X., Highly Efficient and Stable Ni/CeO₂—SiO₂ Catalyst for Dry Reforming of Methane: Effect of Interfacial Structure of Ni/CeO₂ on SiO₂, Applied Catalysis B: Environmental, 246 (2019) 221-231.

81. Reddy, B. M., Khan, A., Nanosized CeO₂—SiO₂, CeO₂—TiO₂, and CeO₂—ZrO₂ Mixed Oxides: Influence of Supporting Oxide on Thermal Stability and Oxygen Storage Properties of Ceria, Catalysis Surveys from Asia, 9 (2005) 155-171.

82. Bharti, B., Kumar, S., Lee, H. N., Kumar, R., Formation of Oxygen Vacancies and Ti³⁺ State in TiO₂ Thin Film and Enhanced Optical Properties by Air Plasma Treatment, Scientific Reports, 6 (2016) 12.

83. Campbell, C. T., Peden, C. H. F., Oxygen Vacancies and Catalysis on Ceria Surfaces, Science, 309 (2005) 713-714.

### EXAMPLE 3

### Effects of Reduction Temperatures on the Activity of Ni/Ce_{0.5}Ti_{0.5}O_{2-δ} in DRM

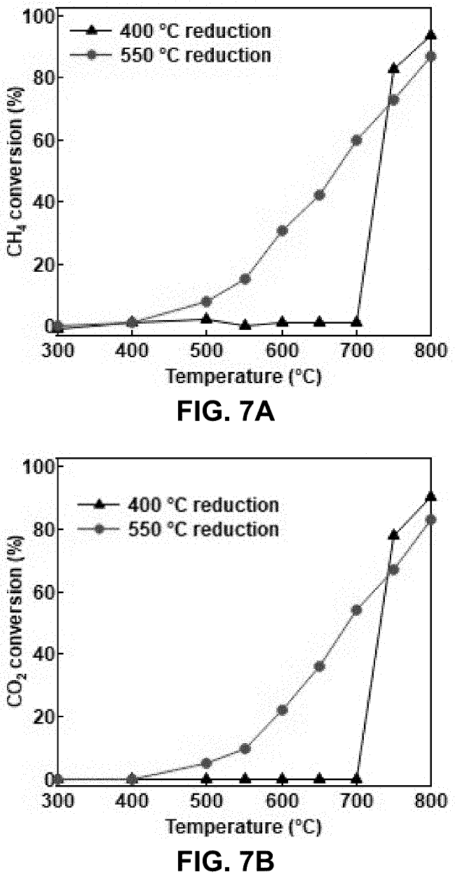

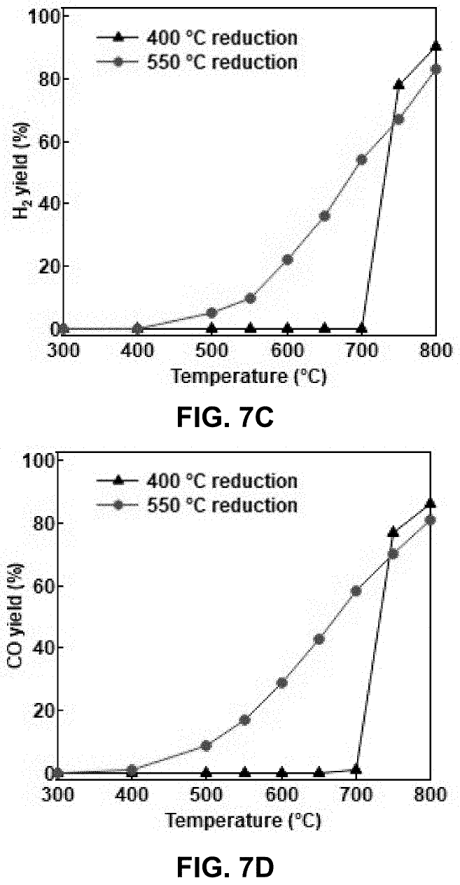

FIGS. 7A-D provide plots showing temperature dependence for DRM reactivity experiments using the present methods including CH₄ conversion (FIG. 7A), CO₂ conversion (FIG. 7B), H₂ yield (FIG. 7C), and CO yield (FIG. 7D) for nominal 5.0 wt. % Ni dispersed over Ce_{0.5}Ti_{0.5}O_{2-δ}. The samples were reduced in 20 mL min⁻¹ H₂ for one hour prior to the DRM reactivity test. One sample was reduced in H₂ at 400° C. (triangle markers) and the other sample was reduced in H₂ at 550° C. (circle markers). The DRM activity data were compared with respect two different reduction temperatures.

In some embodiments, metallic Ni is the active species for methane activation in DRM. For example, NiO is formed over the ceria support during synthesis, which can be reduced to metallic Ni with H₂. As shown in FIGS. 4A-4F, 3.0 wt. % Ni/CeO₂ and 2.4 wt. % Ni/Ce_{0.7}Ti_{0.3}O_{2-δ} catalysts show good DRM activity with reduction at 400° C. for one hour in H₂ with a flow rate of 20 mL min⁻¹. As shown in FIGS. 7A-D, Ni dispersed over Ce_{0.5}Ti_{0.5}O_{2-δ} exhibits catalyst activation at higher reduction temperature (e.g. 550° C.). These results demonstrate that Ti doping in ceria may influence the interaction between ceria and supported Ni that plays an important role in the DRM activity.

### EXAMPLE 4

### Dry Reforming of Methane and Hydrocarbon Mixture Feedstocks using Ceria-Supported Metal Catalysts

Current industrial syngas processes produce high hydrogen content, which restricts the maturation of newer technologies such as higher alcohol and direct dimethyl ether synthesis.[1] Industrial steam reforming catalyst is Ni-based due to its high activity toward C—C and C—H bond cleavage. However, dry reforming has a higher tendency toward coking than steam reforming. Therefore, a coke-resistant support is desirable. The inherent redox properties and oxygen storage capacity of ceria can be enhanced with transition metal dopants such as Ti and Zr.[3] Accordingly, a series of Ti-doped ceria supports (Ce₁₋ₓTiₓO_{2-δ}, x: 0.1-0.5) were synthesized with the sol-gel method and 0.5-10 wt. % Ni was added to the support via the impregnation method. Structures, morphologies, compositions, reducibility of Ni supported on Ti-doped ceria were examined with XRD, SEM, ICP, and H₂-TPR with respect to the Ti dopant concentrations and Ni loadings. Reactivity data were collected with a three-channel on-line GC and mass spectrometry. As discussed below, experimental results for dry reforming of methane indicated conversions close to thermodynamic equilibrium values throughout the temperature range of 25-800° C.[3] Methane conversion increases from 16% at 500° C. to 90% at 800° C.

Natural gas contains mainly methane with a significant percentage of light alkanes with higher hydrogen and carbon contents (e.g. C₂H₆, C₃H₈). The composition of natural gas is dependent on the origins of the natural gas, but it generally contains different compositions of light alkanes (CH₄, C₂H₆, C₃H₈). Compared to DRM, the presence of C₂-C₃ alkanes as minor components in natural gas reforming can vary the H₂/CO ratio in syngas as well as the coke formation and thus affect both the activity and stability of the catalyst. The formulated Ni/Ti-doped ceria catalyst was evaluated with respect to both the reactivity and long-term stability tests for a selected natural gas composition as indicated in Table 1 below

TABLE 1
Composition of a reaction mixture with simulated natural gas
(methane, ethane, and propane) and carbon dioxide. The ratio
of carbon dioxide to combined hydrocarbons is 1.63.

| Reaction gas mixture | Mol percent % |
|---|---|
| Methane | 25 |
| Ethane | 8 |
| Propane | 5 |
| Carbon Dioxide | 62 |

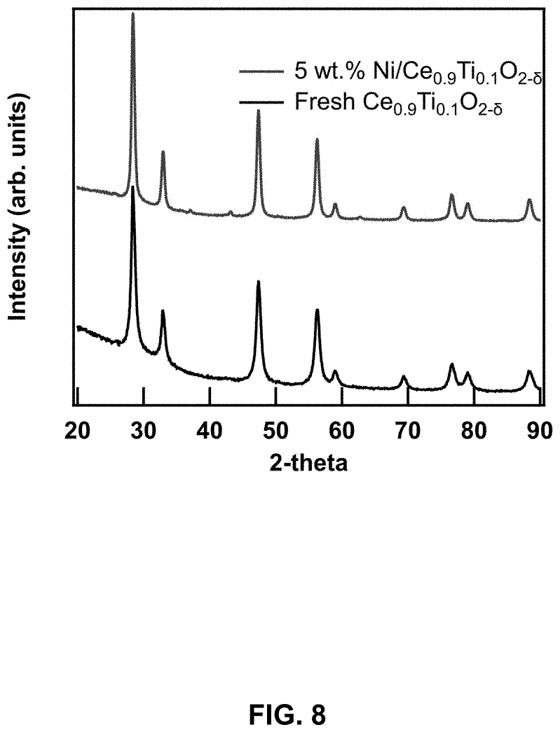

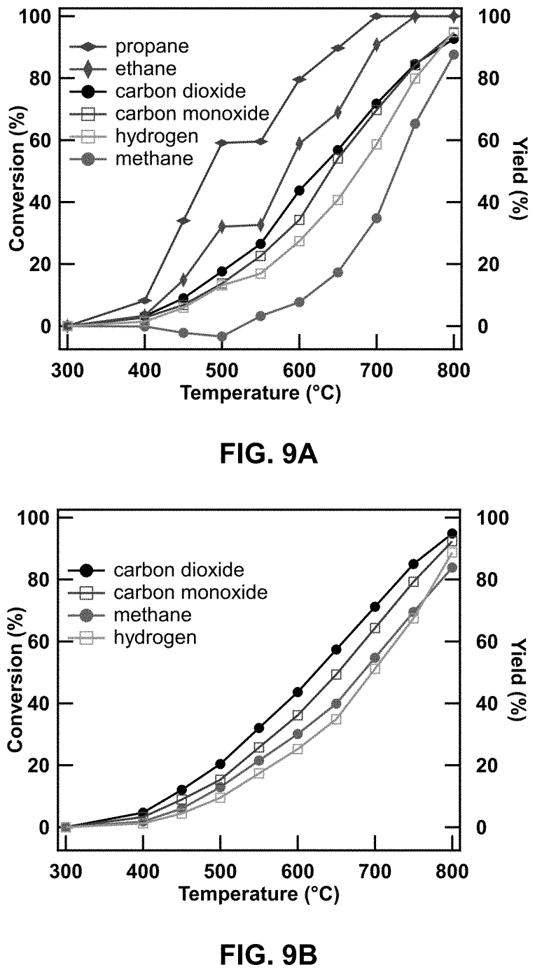

XRD patterns confirm the cubic fluorite structure of the synthesized oxide material of Ce_{0.9}Ti_{0.1}O_{2-δ} as shown in FIG. 8. Ni particles are well-dispersed and small with a nominal 5 wt. % Ni on Ce_{0.9}Ti_{0.1}O_{2-δ}. A temperature-dependent study of dry reforming of mixed C1-C3 hydrocarbons containing 5, 8 and 25% of propane, ethane, and methane, showed propane and ethane conversions at temperatures as low as 400° C. that reach 100% conversion at 700° C. and 750° C., respectively (FIG. 9A). Calculated apparent methane conversion is below 0% between the range of 400-500° C., likely due to low methane reforming activity and methane formation from side reactions related with propane and ethane. However, methane conversion does reach near the values observed in pure DRM studies above 700° C. (FIG. 9B).

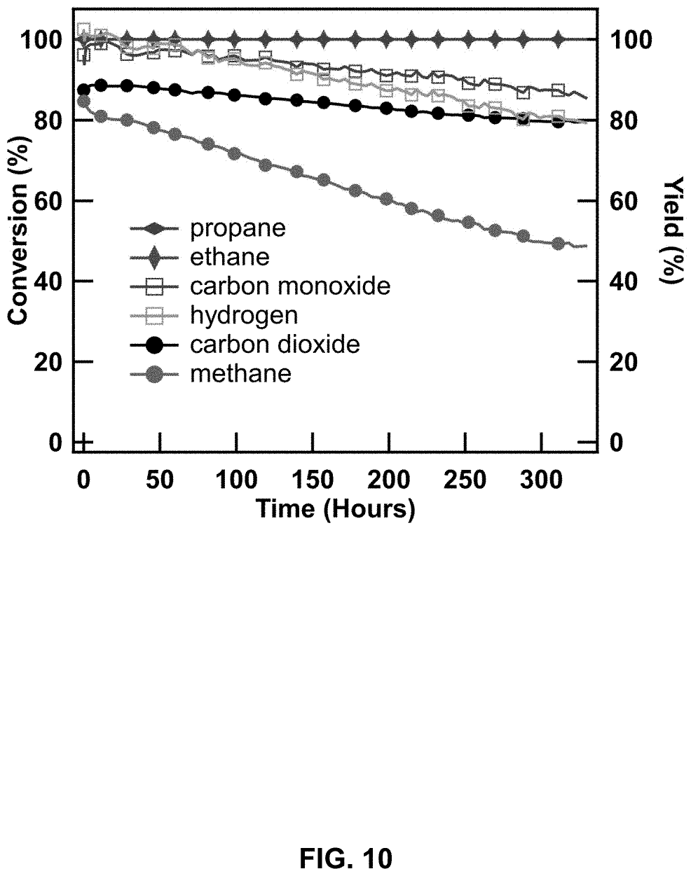

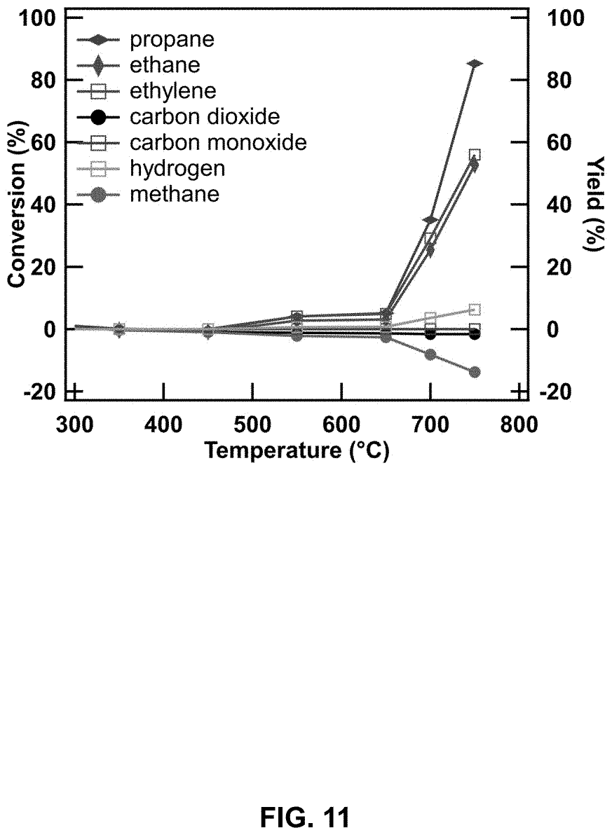

As shown in FIG. 10, a 330-hour stability experiment was performed at 750° C. Propane and ethane conversions were 100% throughout the entire experiment, while methane and CO₂ conversions slowly decreased. A greater extent in the decrease of apparent methane conversion compared to that of CO₂ is consistent to the suggestion of methane formation due to thermal decomposition and side reactions involving propane and ethane in addition to potential loss in the catalyst activity from coking. Increasing the concentration of CO₂ in the reaction mixture may enhance and sustain the reforming of methane activity. Throughout the 330-hour duration, CO₂ conversion, carbon monoxide and hydrogen yields decrease less rapidly, implying a sustained high overall dry reforming activity. Thus, Ni/Ti-doped ceria exhibits good catalytic behavior for dry reforming of mixed hydrocarbons.

### REFERENCES ASSOCIATED WITH EXAMPLE 4

1. Wittich, K., et al., Catalytic Dry Reforming of Methane: Insights from Model Systems. ChemCatChem, 2020, 12, (8), 2130-2147.

2. Shah, Y. T. and T. H. Gardner, Dry Reforming of Hydrocarbon Feedstocks. Catalysis Reviews, 2014, 56, (4), 476-536.

3. Pakhare, D., Spivey, J., A Review of Dry (CO₂) Reforming of Methane over Noble Metal Catalysts. Chemical Society Reviews, 2014, 43, (22), 7813-7837.

### EXAMPLE 5

### Comparisons of Dry Reforming of Methane, Ethane, and Propane using Ceria-Supported Metal Catalysts

The performance of the Ceria-supported catalysts in reforming pure methane, ethane and propane individually rather than as a mixed feedstock was investigated. A nominal 5 wt. % Ni/Ce_{0.9}Ti_{0.1}O₂ catalyst was used. Dry reforming of methane (DRM) occurs according to the following equation:

CH₄+CO₂ [symbol] 2H₂+2CO

Dry reforming of ethane (DRE) occurs according to the following equation:

C₂H₆+2CO₂ [symbol] 3H₂+4CO

Dry reforming of propane (DRP) occurs according to the following equation:

C₃H_{8b+3}CO₂ [symbol] 4H₂+6CO

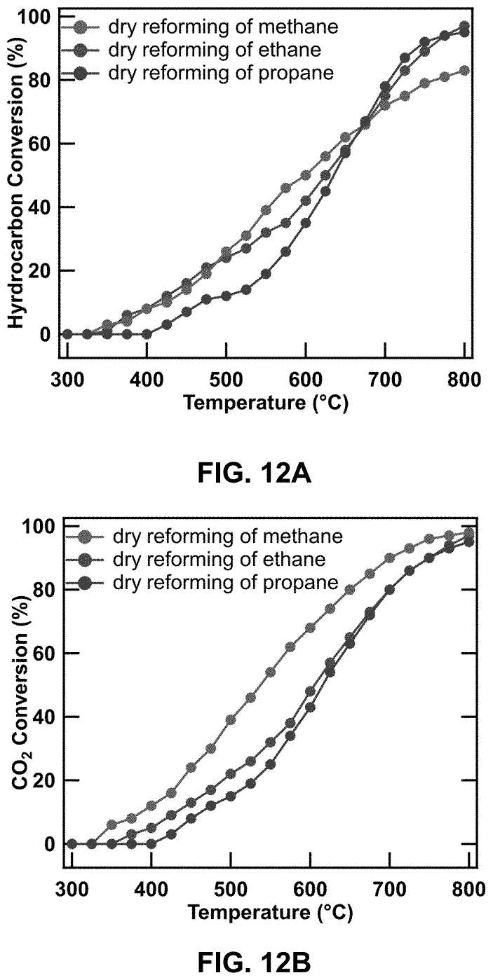

For the DRM, the relative flow rates of He/methane/CO₂ were 35/30/0/30 mL min⁻¹. He was used as an internal standard for the mass spectrometry analysis. For the DRE, the relative flow rates of He/ethane/CO₂ were 35/20/40 mL min⁻¹. For the DRP, the relative flow rates of He/propane/CO₂ were 35/0/15/45 mL min⁻¹. The hydrocarbon conversion and CO₂ conversion results are shown in FIGS. 12A-B. The catalyst exhibits activity toward DRM, DRE, and DRP. Propane, ethane, and methane conversions were observed at temperatures as low as 425° C., 375° C. and 350° C. respectively.

### Statements Regarding Incorporation by Reference and Variations

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a Markush group or other grouping is used herein, all individual members of the group and all combinations and subcombinations possible of the group are intended to be individually included in the disclosure. Every formulation or combination of components described or exemplified can be used to practice the invention, unless otherwise stated. Specific names of compounds are intended to be exemplary, as it is known that one of ordinary skill in the art can name the same compounds differently.

One of ordinary skill in the art will appreciate that methods, device elements, starting materials, and synthetic methods other than those specifically exemplified can be employed in the practice of the invention without resort to undue experimentation. All art-known functional equivalents, of any such methods, device elements, starting materials, and synthetic methods are intended to be included in this invention. Whenever a range is given in the specification, for example, a temperature range, a time range, or a composition range, all intermediate ranges and subranges, as well as all individual values included in the ranges given are intended to be included in the disclosure.

The invention illustratively described herein suitably may be practiced in the absence of any element or elements, limitation or limitations which is not specifically disclosed herein.

Without wishing to be bound by any particular theory, there can be discussion herein of beliefs or understandings of underlying principles relating to the invention. It is recognized that regardless of the ultimate correctness of any mechanistic explanation or hypothesis, an embodiment of the invention can nonetheless be operative and useful.

Every material, system, formulation, combination of components, or method described or exemplified herein can be used to practice the invention, unless otherwise stated.

Whenever a range is given in the specification, for example, a temperature range, a time range, a composition or a concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. A method for processing a hydrocarbon feedstock, the method comprising the steps of:
contacting said hydrocarbon feedstock with a doped ceria-supported metal catalyst comprising an active metal and a mixed oxide support, thereby generating a syngas product comprising H₂ and CO;
wherein said doped ceria-supported metal catalyst is of the formula (FX1):
M/Ce₁₋ₓBₓO_{2-δ} (FX1);
wherein M is one or more metals selected from Ni, Co, Pd, Rh, and Pt or a mixture thereof; B is one or more dopants selected from Ti, Zr, Mn, and La; x is a number selected from the range of 0.05 to 0.5 and wherein δ represents oxygen deficiency; and
wherein said feedstock comprises methane with one or more additional hydrocarbon components and CO₂.

2-13. (canceled)

14. The method of claim 1, wherein said doped catalyst support maintains the structure of pure ceria and produces mixed metal oxides

15. The method of claim 1, wherein said one or more metals (M) are provided as particles or clusters having an average size dimension up to 1 micron.

16-18. (canceled)

19. The method of claim 1, wherein said one or more metals (M) in formula (FX1) is Ni; and wherein Ni has a weight percent in the catalyst selected from the range of 2.0-3.0 wt. %.

20. The method of claim 1, wherein said one or more metals (M) in formula (FX1) is Ni; and wherein Ni has a weight percent in the catalyst 2.4±0.5 wt. %.

21-22. (canceled)

23. The method of claim 1, wherein said one or more dopants (B) in formula (FX1) is Ti, wherein the ratio of Ce to Ti is selected form the range of 2.0 to 2.7.

24. The method of claim 1, wherein said one or more dopants (B) in formula (FX1) is Ti, wherein the ratio of Ce to Ti is 2.3±0.3.

25-26. (canceled)

27. The method of claim 1, wherein said one or more metals (M) in formula (FX1) is Ni; wherein the weight percent of Ni in the catalyst is selected from the range of 1.5-2.5 wt. % and wherein the ratio of Ce to Ti is selected from the range of 2.0 to 2.7.

28-31. (canceled)

32. The method of claim 1, wherein said step of contacting said mixed feedstock with a doped ceria-supported metal catalyst is carried out at a temperature selected over the range of 600° C. to 800° C.

33. (canceled)

34. The method of claim 1, wherein said method is characterized by a methane conversion efficiency equal to or greater than 70% at a temperature of 650° C. or greater.

35. The method of claim 1, wherein said method is characterized by a methane conversion efficiency equal to or greater than 60% at a temperature of 750° C. or greater.

36. The method of claim 1, wherein said method is characterized by an ethane conversion efficiency equal to or greater than 70% at a temperature of 650° C. or greater.

37. The method of claim 1, wherein said method is characterized by an ethane conversion efficiency equal to or greater than 90% at a temperature of 750° C. or greater.

38. The method of claim 1, wherein said method is characterized by an propane conversion efficiency equal to or greater than 90% at a temperature of 750° C. or greater.

39. The method of claim 1, wherein said method is characterized by a ratio of H₂ produced to CO produced equal to or greater than 90% at a temperature of 650° C. or greater.

40-42. (canceled)

43. A catalyst comprising a doped ceria-supported metal of the formula (FX1):
M/Ce₁₋ₓBₓO_{2-δ} (FX1);
wherein M is one or more metals selected from Ni, Co, Pd, Rh, and Pt or a mixture thereof; B is at least two dopants selected from Ti, Zr, Mn and La; x is a number selected from the range of 0.05 to 0.5 and wherein δ represents oxygen deficiency.

44. (canceled)

45. The catalyst of claim 44, wherein said doped catalyst support maintains the structure of pure ceria and forms mixed metal oxides.

46-48. (canceled)

49. The catalyst of claim 43, wherein said one or more metals (M) in formula (FX1) is Ni; and wherein Ni has a weight percent in the catalyst selected from the range of 2.0-3.0 wt. %; and wherein the Ni is provided as particles or clusters having a size dimension up yo 1 micron.

50. The catalyst of claim 43, wherein said one or more metals (M) in formula (FX1) is Ni; and wherein Ni has a weight percent in the catalyst 2.4±0.5 wt. %.

51-53. (canceled)

54. The catalyst of claim 43; wherein said one or more metals (M) in formula (FX1) is Ni characterized by a weight percent of 1.5-2.5 wt. %, and wherein said at least two dopants in formula (FX1) is Ti and at least one other different dopant; wherein the ratio of Ce to B is selected form the range of 2.0 to 2.7.

55-58. (canceled)
